(19) United States
(12) Patent Application Publication
(10) Pub. No.: US 2017/0061102 A1
(43) Pub. Date: Mar. 2, 2017

(54) METHODS AND SYSTEMS FOR IDENTIFYING OR SELECTING HIGH VALUE PATIENTS

(71) Applicant: PRESIDENT AND FELLOWS OF HARVARD COLLEGE, Cambridge, MA (US)

(72) Inventors: Griffin M. WEBER, Boston, MA (US); Isaac S. KOHANE, Newton, MA (US)

(21) Appl. No.: 15/120,475

(22) PCT Filed: Feb. 20, 2015
(86) PCT No.: PCT/US15/16872

§ 371 Date: Aug. 19, 2016

Related U.S. Application Data
(60) Provisional application No. 61/943,043, filed on Feb. 21, 2014.

(51) Int. Cl. G06F 19/00; G06F 17/30; G06Q 50/00

(52) U.S. Cl. CPC G06F 19/363; G06F 19/322; G06Q 50/01; G06F 17/30522

(57) ABSTRACT

Embodiments of various aspects described herein are directed to systems (e.g., computer systems), computer-implemented methods, and non-transitory computer-readable storage media for identifying or selecting high value patients and applications thereof.

### CROSS-REFERENCE TO RELATED APPLICATIONS

This application claims benefit under 35 U.S.C. §119(e) of the U.S. Provisional Application No. 61/943,043 filed Feb. 21, 2014, the contents of which are incorporated herein by reference in their entirety.

### TECHNICAL FIELD

Described herein relates generally to systems for identifying or selecting high value patients and applications thereof.

### BACKGROUND

Developing a new drug is typically expensive, in part, due to the cost of conducting multiple clinical trials required for drug approval. Typically, clinical trials leading to drug approval can require approximately 2000 to 15,000 study subjects.

One of the expensive and difficult parts of conducting clinical trials is recruiting patients. Investigators typically take a brute force approach by reading thousands of patient charts to find eligible subjects or by advertising with the hope that a patient will contact them. Electronic health records (EHRs) have recently made a search for eligible patients easier, but a great amount of effort is still required to review the data from these systems and recruit the patients. Thus, patient recruitment contributes to a significant cost of conducting the clinical trials. For example, on average, it takes about 6.8 years to conduct clinical trials before drugs generally get approved, and the mean cost per patient in clinical trials worldwide can range approximately from $5000 (Phase IV) to $20,000 (Phase I). See, e.g., Clinical Trials Facts & Figures, online accessible at http://www.ciscrp.org/patient/facts_graphs.html. Accelerating clinical trials can lead to increased profits for drug manufacturers or companies. Accordingly, there is a need for a more systematic and efficient method to evaluate and select patients to be involved in clinical trials.

### SUMMARY

There is a need to evaluate and recruit study subjects for clinical trials in a more systematic and efficient manner such that the cost of conducting clinical trials and thus the cost of drug development can be reduced. Embodiments of various aspects described herein relate to systems (e.g., computer systems), methods and non-transitory computer-readable storage media that assign values to patients based on the extent to which they are desired as study subjects for one or more clinical trials. Unlike the existing approaches of selecting individuals for each specific clinical trial based on mere matching eligibility criteria of each clinical trial against patient profiles (e.g., patient charts and/or electronic health records), the systems, methods and non-transitory computer-readable storage media described herein provide a systematic approach to rank or rate patients according to their values or desirability to one or more clinical trials based on economic factors such as demand for study subjects and supply of qualified patients for the clinical trials. In some embodiments, the values of patients as study subjects can further take into account of other financial or economic variables, e.g., but not limited to, potential profit of a drug to be studied in a clinical trial, the number of remaining years before the patent of the drug expires, i.e., the number of years left for exclusive rights to sale and manufacturing of the drug, and/or cost of running the clinical trial). Thus, embodiments of various aspects provided herein relate to systems and non-transitory computer-readable storage media for identifying high value patients and/or selecting high value patients for clinical trials, as well as methods and/or applications of using the systems and non-transitory computer-readable storage media described herein. In some embodiments, the systems (e.g., computer systems), methods and non-transitory computer-readable storage media provided herein can assign monetary or relative values to patients.

In some embodiments, value of each patient can be proportional to the number of clinical trials that he or she is eligible for.

Not only can the systems, methods, and non-transitory computer-readable storage media be used to determine an individual patient value, but can also be used to determine a group patient value, e.g., value of a group of patients with at least one or more (e.g., at least two or more) common characteristics, e.g., but not limited to, age, sex, diagnosis, and/or in demand from a specific clinical trial. For example, a group patient value can be determined by computing the average or mean value of patients in a specific group.

The systems, methods and non-transitory computer-readable storage media described herein can be used to systematically and formally evaluating patients of value in ways that can have considerable effect on the bottom line of companies and non-profits involved in clinical trials recruitment. By way of example only, by adjusting one or more parameters involved in determination of patient values (e.g., change in eligibility requirements of study subjects for clinical trials, and/or using different methods or algorithms (e.g., with different yields of patient recruitment) to identify qualified patients for clinical trials), a second set of patient values can be determined with a different set of identified patients. Thus, the second set of patient values can be compared to the first set of patient values, e.g., to determine optimum patient recruitment strategy.

### BRIEF DESCRIPTION OF THE DRAWINGS

FIG. 1 is a confusion matrix for using a computer algorithm to search for eligible patients in EHR data. Both false matches (Type I error) and false non-matches (Type II error) increase enrollment costs.

FIGS. 2A-2D are example distributions of several measures of health care dynamics. (FIG. 2A) Time of day when white blood cell (WBC) tests are ordered, (FIG. 2B) number of days until a WBC test is repeated for the same patient, (FIG. 2C) fact count growth chart by age, and (FIG. 2D) patient health state by age as defined by diagnosis types and counts.

FIG. 3 is an example receiver operating characteristic (ROC) chart. A perfect algorithm correctly identifies all eligible patients and does not select any ineligible patients. The less inaccurate the algorithm, the higher the enrollment costs.

FIG. 4 is a hypothetical graph showing how changes in an EHR over time can affect the enrollment rate of an algorithm. From the prior one year of data, algorithm “A” appears to be identifying new patients at a faster rate than “B” and achieving higher enrollment after five years. However, “B” has reached a steady-state, and the confidence of its enrollment rate continuing might be higher than that of algorithm “A”, which might plateau soon.

FIG. 5 is a schematic diagram showing an example optimal recruitment strategy. Recruiting patients faster costs more, but the sooner enrollment targets are met, the fewer sales of the drug are lost due to delays in finishing the trials. The balance of the two factors sets the cost drug manufacturers would pay for recruitment.

FIG. 6 is a block diagram showing a system in accordance with one or more embodiments described herein, e.g., for identifying or selecting high value patients for clinical trials.

FIG. 7 is an exemplary set of instructions on a computer readable storage medium for use with the systems described herein.

FIGS. 8A-8B are data graphs showing the number of patients per trial in linear scale (FIG. 8A) and vertical logarithmic scale (FIG. 8B), respectively.

FIGS. 9A-9B are data graphs showing the number of eligible clinical trials per patient in linear scale (FIG. 9A) and horizontal logarithmic scale (FIG. 9B), respectively.

FIG. 10 is a data graph showing supply and demand of patients by age for clinical trials as well as mean or average patient value of each age group.

FIG. 11 is a data graph showing that patients eligible for some clinical trials (e.g., lung cancer studies) are also eligible for many other trials.

FIG. 12 is a data graph showing the number of eligible clinical trials per lung cancer patient.

FIG. 13 is a data graph showing supply and demand of patients by age for a lung cancer clinical trial as well as mean or average patient value of each age group.

### DETAILED DESCRIPTION OF THE INVENTION

There is a need to evaluate and recruit study subjects for clinical trials in a more systematic and efficient manner such that the cost of conducting clinical trials and thus the cost of drug development can be reduced. Unlike the existing approaches of selecting individuals for each specific clinical trial based on mere matching eligibility criteria of each clinical trial against patient profiles (e.g., patient charts and/or electronic health records), the systems, methods and non-transitory computer-readable storage media described herein provide a systematic approach of identifying high value patients, which, for example, can be selected as study subjects for multiple clinical trials. In particular, the inventors have developed a systematic approach to rank or rate patients' value as potential study subjects for one or more clinical trials. In accordance with various embodiments described herein, the values of patients as study subjects are computed based on a number of parameters, including, but are not limited to, the demand for study subjects and supply of patients that are qualified as study subjects in clinical trials. In some embodiments, the values of patients as study subjects can further take into account of other financial or economic variables, e.g., but not limited to, potential profit of a drug to be studied in a clinical trial, the number of remaining years before the patent of the drug expires, i.e., the number of years left for exclusive rights to sale and manufacturing of the drug, and/or cost of running the clinical trial). Thus, embodiments of various aspects provided herein relate to systems and non-transitory computer-readable storage media for identifying high value patients and/or selecting high value patients for clinical trials, as well as methods and/or applications of using the systems and non-transitory computer-readable storage media described herein. In some embodiments, the systems (e.g., computer systems), methods, and non-transitory computer-readable storage media provided herein can assign monetary or relative values to patients based on the extent to which they are desired as study subjects for one or more clinical trials.

As used herein, the term “value” in reference to value of patient(s) as study subject(s) for clinical trial(s) refers to degree of desirability of the patient(s) as study subject(s) in one or more clinical trials. The value of patients can increase when there is a higher demand for these patients with certain profiles, or when the supply of patients with these certain profiles are lower, or when the accessibility to these patients or willingness of these patients to participate in a clinical trial is higher. The value of a patient can also increase with the number of clinical trials for which they are eligible. Patients can be eligible for either a treatment group or a control group of a clinical trial. In some clinical trials where finding normal healthy subjects (controls) in a clinical setting is more difficult than finding patients with a disease or disorder, the normal healthy subjects can have a higher value that patients with a disease or disorder.

The value of a patient can be expressed as a monetary amount and/or an index score, which can be a number, an alphabet, or a word. For example, in some embodiments, the value of a patient can be expressed as an actual monetary amount of which the patient is worth. Alternatively, the value of a patient can be expressed as an index score or group index relative to other patients. By way of example only, where a patient A is more desired as a study subject than patient B, the value of patient A can also be expressed as a number, e.g., “1,” an alphabet, e.g., “A,” or a word, e.g., “high,” while the value patient B can be expressed as “2,” “B,” or “medium.” Accordingly, in some embodiments, the value of a patient can be based on a continuous scale, i.e., a numerical scale including any number and fractions within the scale. In some embodiments, the value of a patient can be based on a discrete scale, e.g., a numeric scale with a finite set of numbers (e.g., 1, 2, 3, 4, 5, wherein each integer represents a different value), a letter scale (e.g., A, B, C, . . . , wherein each letter represents a different value), or a group scale (e.g., “high,” “medium,” and “low”). In these embodiments, patients can be categorized into different groups of a discrete scale based on the threshold set for each group.

As used herein, the term “high value patient” refers to a patient that is more desired than at least one or more patients as a study subject (either in a test or control group of a treatment) in a clinical trial. In some embodiments, the high value patient can be a patient who meets the eligibility criteria for either the test or control groups of a treatment that (1) is being studied by more than one or multiple clinical trials, (2) has few patients who would qualify for the clinical trial, (3) has high monetary value to the drug manufacturer, and any combinations thereof. In some embodiments, the high value patients can include patients with a more complete health record, e.g., at least about 50%, at least about 60%, at least about 70%, at least about 80%, at least about 90%, at least about 95% or more (including 100%) completion of their health records (because these patients can have a higher chance of being selected from a query of an EHR). In some embodiments, the high value patients can be normal healthy subjects in a hospital EHR. In some embodiments, the high value patients can be patients with a disease that is a high priority of the National Institutes of Health (NIH), e.g., when the clinical trial is federally funded.

As described above, the value or desirability of a patient can be expressed in many different ways. Thus, a high value patient is not necessarily reflected by a higher numerical value assigned to the patient. That is, in some embodiments, a high value patient can have a smaller numerical value or score than a patient that is less desirable as a study subject in a clinical trial. In alternative embodiments, a high value patient can have a higher numerical number or score than a patient that is less desirable as a study subject in a clinical trial. In some embodiments where the value of a patient is expressed as a monetary worth value, a high value patient can refer to a patient with a monetary worth value in the 50% percentile or higher, including, e.g., the 60% percentile, the 70% percentile, the 80% percentile, the 90% percentile, the 95% percentile or higher. For example, a monetary value equal to or greater than 95% percent of the monetary values of a patient population is said to be in the 95% percentile.

The systems and methods described herein can be used in various circumstances where patient recruitment for a clinical trial is involved. Examples of such circumstances include, but are not limited to, a hospital determining which clinical trial its patients should participate in and setting a price on its patients to drug companies; a drug company optimizing their recruiting strategy for a clinical trial; estimating the cost of patient recruitment for a clinical trial; and determining an optimum study population for a clinical trial. In some embodiments, by identifying high value patients, hospitals can invest their resources to high value patients, e.g., to review the quality (e.g., accuracy and/or completeness) of their health records, to enter them into registries, and/or to ensure their contact information is accurate before they are needed for a clinical trial.

In some embodiments of various aspects described herein, patient value can be proportional to the number of clinical trials that a patient is or patients are eligible for.

Not only can the systems, methods, and non-transitory computer-readable storage media described herein be used to determine an individual patient value, but can also be used to determine a group patient value, e.g., value of a group of patients with at least one or more (e.g., at least two or more) common characteristics, e.g., but not limited to, age, gender, diagnosis, and/or eligibility to a specific clinical trial. For example, a group patient value can be determined by computing the average or mean value of patients in a specific group. In one embodiment, a group patient value can correspond to the mean number of eligible clinical trials per eligible patient. Stated another way, it is a measure of the average value of the patients a clinical trial is trying to recruit. As shown in the Examples herein, in one embodiment, a group patient value of patients in a given age or age group can be determined by taking the average of the patient value of patients in the given age or age group. In another embodiment, a group patient value can correspond to mean patient value of patients of a given age or age group who are eligible for a particular clinical trial.

### Systems, Non-Transitory Computer-Readable Storage Media, and Computer-Implemented Methods, e.g., for Identifying or Selecting Subjects or High Value Patients for Clinical Trials

Embodiments of one aspect provide for systems (and computer readable media for causing computer systems) to, e.g., identify or select study subjects for clinical trials, and/or to perform the methods of various aspects described herein.

A system (e.g., a computer system) for selecting study subjects for at least one clinical trial, wherein the study subjects are ranked or thresholded by a value computed or determined by the system is provided. The system comprises: a computer system comprising one or more processors; and memory to store one or more programs, the one or more programs comprising instructions for:
a. computing or determining, for each patient in a patient population, a value as a function of parameters comprising:
   i. supply of qualified patients to at least a subset of clinical trials, wherein said each patient is qualified for the at least a subset of the clinical trials; and wherein the supply of the qualified patients is identified based on patient profiles and eligibility criteria of the clinical trials;
   ii. demand for study subjects of the at least a subset of the clinical trials;
wherein the value provides a relative ranking of said each patient to other patients in the patient population or a relative value of said each patient to a pre-determined threshold; and
b. displaying a content that comprises a signal indicative of information associated with at least a subset of the patient population, wherein the signal is selected from the group consisting of a signal indicative of ranking of at least a subset of the patient population, a signal indicative of values of at least a subset of the patient population, a signal indicative of at least of a subset of the patient population selected for the clinical trial, a signal indicative of no patient selected for the clinical trial, and any combination thereof,
   thereby selecting patients of high value as study subjects for the at least one clinical trial. In some embodiments, the patients of high value selected for one or more clinical trials can be control subjects. In some embodiments, the patients of high value selected for one or more clinical trials can be test subjects for a treatment with a drug to be studied in the clinical trial.

As used herein, the term “supply of qualified patients to at least a subset of clinical trials” refers to the number of qualified patients that is available to be recruited into each of the clinical trials as study subjects. The supply of qualified patients to a clinical trial generally decreases when a disease being studied is rare or is an orphan disease, i.e., a disease that affects a small percentage of the population.

As used herein, the term “demand for study subjects” refers to the number of qualified patients that a clinical trial needs to enroll as study subjects to complete the study. The demand for study subjects generally increases when the target enrollment is higher. Additionally or alternatively, the demand for study subjects can also increase with higher potential earnings or revenues from a drug being studied. For example, the drug is an expensive drug, and/or the market of target patients to be treated with the drug is large.

In some embodiments, the program(s) in the systems described herein can provide instructions to search at least one database comprising the patient profiles to identify the qualified patients. Not only can the program(s) in the systems described herein provide instructions to identify qualified patients for a specific clinical trial, the program(s) can also determine how many and/or identify what other clinical trials can each patient in the patient population be eligible as study subjects.

As used herein, the term “study subjects” refers to patients that are eligible or qualified for participation in a clinical trial. The study subjects can be either for a test group or a control group of a treatment being studied in a clinical trial.

As used interchangeably herein, the terms “eligible” and “qualified” with respect to selection of patients as study subjects for a clinical trial refer to patients satisfying at least about 30% or more of the eligibility criteria of the clinical trial. In some embodiments, an eligible or qualified patient (i.e., a study subject in a clinical trial) is a patient who satisfies at least about 30% or more, including, e.g., at least about 40%, at least about 50%, at least about 60%, at least about 70%, at least about 80%, at least about 90%, at least about 95% or more, including 100%, of the eligibility criteria of a clinical trial. Patients can be eligible for either a treatment group or a control group of a clinical trial. The degree of eligibility can be varied or optimized to expand or tighten the size of the qualified patient pool, e.g., based on the patient recruitment strategy. For example, expanding the size of the qualified patient pool can allow recruiting patients to a clinical trial faster at a lower cost, e.g., by minimizing the chance of having a delay in completing the trial that would otherwise result in a delay in the sale of a drug to be evaluated in the clinical trial.

In some embodiments, the values of patients can be computed or determined as a function of one or more additional parameters that would increase the accuracy of the expected patient value. Examples of such additional parameters include, but are not limited to, an expected patient enrollment cost involved in enrolling a patient to a clinical trial, an expected efficiency of identifying the patient or yield of patient recruitment, an expected time cost associated with duration of the clinical trials, the number of years granted for exclusive rights to a drug, or any combinations thereof. Examples of expected patient enrollment cost associated with identifying the patient can include, but are not limited to, costs of obtaining Institutional Review Board (IRB) approval, identifying patients to contact, getting approval from providers to contact their patients, contacting the patients, screening the patients for clinical trials, and any combinations thereof. The screening cost per patient can include the cost of patients who are eligible but cannot be recruited.

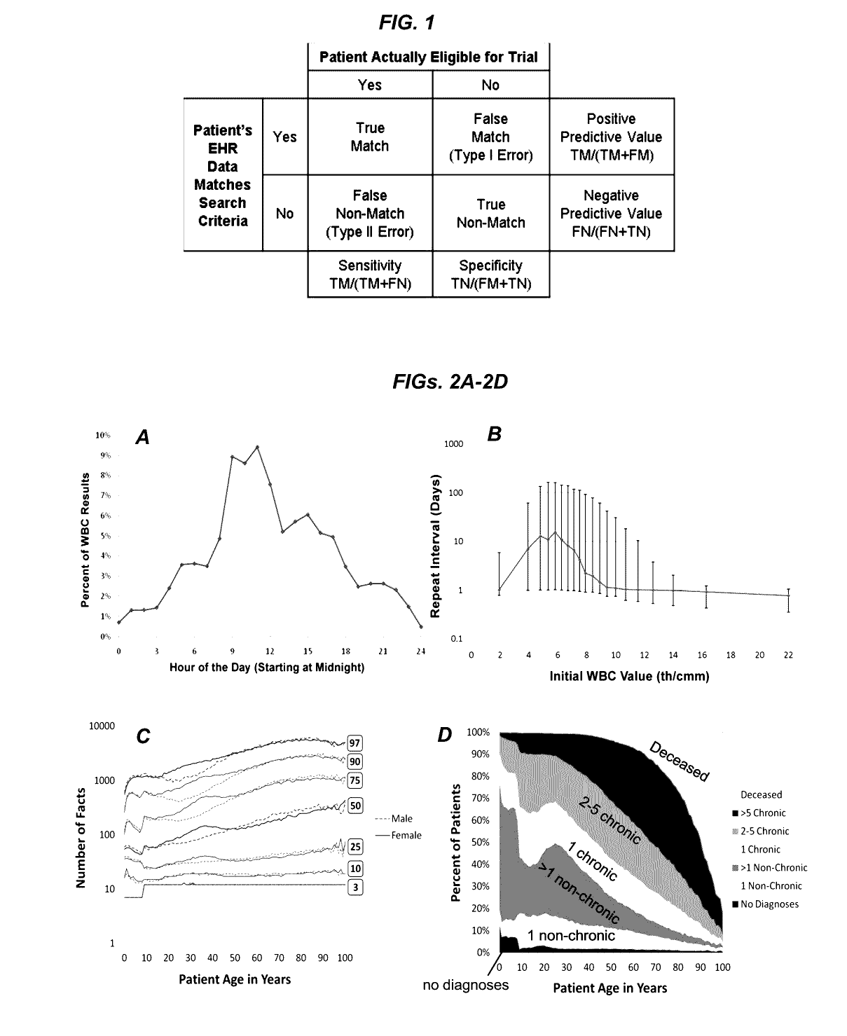

The expected efficiency of identifying qualified patients for clinical trials can be characterized by any statistical measures known in the art, including, e.g., but not limited to, sensitivity (defined as a ratio of true matches to a total of true matches and false non-matches as shown in FIG. 1), specificity (defined as a ratio of true non-matches to a total of false matches and true non-matches as shown in FIG. 1), and/or positive predictive value (defined as a ratio of false matches to a total of false matches and true non-matches as shown in FIG. 1) of at least one or more method or algorithm used for identifying the qualified patient for the clinical trials (e.g., a query of EHR database based on eligibility criteria of clinical trials vs. a manual review of the data of patients).

The expected time cost for determination of patient values can be associated with the number of years taken to complete a clinical trial, or the number of years remaining between completion of the clinical trial and expiration of a patent for a drug to be studied in the clinical trial. The expected time cost associated with a clinical trial can vary depending on the time duration required to reach the enrollment target size for the clinical trial.

In some embodiments, the step (a) of computing or determining patient values can comprise:

(i) computing, for each patient y in the patient population, a first trial-specific value to a first clinical trial (Vₓ₌₁) as a function of parameters comprising (i) expected compensation for each study subject (Compₓ₌₁), (ii) eligibility of the patient to the first clinical trial (Eligibilityₓ₌₁); (iii) demand for study subjects in the first clinical trial (Demandₓ₌₁); and (iv) supply of qualified patients in the first clinical trial (Supplyₓ₌₁); and

(ii) computing, for each patient y, the value based on at least the first trial-specific value to the first clinical trial (Vₓ₌₁) computed in (i) and a second trial-specific value of the patient to a second clinical trial (Vₓ₌₂)

The expected compensation for each study subject (Compₓ) can vary with a number of factors including, e.g., but not limited to prevalence of a disease to be treated with a drug studied in the clinical trial, and/or the potential profit from the drug.

In some embodiments, for each patient y, the first trial-specific value to the first clinical trial (Vₓ₌₁) and the second trial-specific value to the second clinical trial (Vₓ₌₂) can each be independently computed with the following correlation (1):

$${V}_{x} ( patient\_y ) ∼ {Comp}_{x} * {Eligibility}_{x} * \frac{{Demand}_{x}}{{Supply}_{x}} \qquad Correlation ( 1 )$$

In some embodiments, the computation of the Vₓ(patient_y) in Correlation (1) can include an expected patient enrollment cost involved in enrolling a patient to a clinical trial, an expected efficiency of identifying the patient or yield of patient recruitment, or a combination thereof. Examples of expected cost associated with identifying the patient can include, but are not limited to, costs of obtaining Institutional Review Board (IRB) approval, identifying patients to contact, getting approval from providers to contact their patients, contacting the patients, screening the patients for clinical trials, and any combinations thereof. The screening cost per patient can include the cost of patients who are eligible but cannot be recruited.

Not all the qualified patients can actually be recruited for a clinical trial. For example, some of the qualified patients may not be interested in participating in a clinical trial. Quantified patients who initially appear eligible for the clinical trial may not pass screening. Accordingly, in some embodiments, the yield of patient recruitment can be included in the determination of values of patients. As used herein, the term “yield of patient recruitment” refers to a percentage of qualified patients that can actually be recruited in a clinical trial. Higher percentages of yield of patient recruitment can reduce the cost of running a clinical trial.

In some embodiments, for each patient y, the value (V) can be computed with the following correlation (2):

$$V ( patient\_y ) ∼ {\sum }_{x = 1} {Comp}_{x} * {Eligibility}_{x} * \frac{{Demand}_{x}}{{Supply}_{x}} \qquad Correlation ( 2 )$$

In some embodiments, the value (V) can be computed using the following method (I). Suppose there are p patients and c clinical trials. Additional assumptions include: (1) recruitment occurs instantaneously instead of over several years; (2) patients can simultaneously participate in multiple trials; (3) the yield of patient recruitment is 100%, i.e., all patients contacted are eligible and can be recruited for the clinical trial; and (4) the number of qualified patients exceeds the enrollment targets (i.e., the demand for study subjects). One of skill in the art can modify the following correlations based on any change in the assumptions. For example, if the yield of patient recruitment is less than 100%, the yield can be accounted for in determining the actual supply of qualified patients.

Let Prevalence(x) be the number of patients who could be treated with a drug x studied in a clinical trial x.

Let PerPatientProfit(x) be the amount of profit selling the drug x to a single patient y.

Let DrugValue(x) be the potential profit from the drug x being studied in the clinical trial x.

DrugValue(x)˜Prevalence(x)·PerPatientProfit(x)

Let EnrollmentTarget(x) (i.e., Demandₓ) be the number of study subjects that the clinical trial x needs to enroll to complete the study.

Let PerSubjectValue(x) (i.e., Compₓ) be the amount the manufacturer of drug x is willing to pay per subject.

$$PerSubjectValue ( x ) ∼ \frac{DrugValue ( x )}{EnrollmentTarget ( x )}$$

Let Eligible(x,y) (i.e., Eligibilityₓ) be 1 if patient y can be recruited to trial x, and 0 otherwise.

Let TotalEligible(x) (i.e., Supplyₓ) be the total number of patients who are eligible for the trial.

$$TotalEligible ( x ) = {\sum }_{y = 1}^{p} Eligible ( x , y )$$

Let ChanceSelected(x,y) be the chance that patient y will be selected for trial x.

$$Chance Selected ( x , y ) ∼ Eligible ( x , y ) \cdot \frac{EnrollmentTarget ( x )}{Total Eligible ( x )}$$

Let ValueToTrial(x,y) (i.e., Vₓ (patient y)) be the value of patient y to trial x.

ValueToTrial(x,y)˜PerSubjectValue(x)·ChanceSelected(x,y)

Let PatientValue(y) (i.e., V(patient y)) be the total value of patient y across all c clinical trials.

$$PatientValue ( y ) ∼ {\sum }_{x = 1}^{σ} ValueToTrial ( x , y )$$

$$PatientValue ( y ) ∼ {\sum }_{x = 1}^{σ} PerSubjectValue ( x ) \cdot ChanceSelected ( x , y )$$

$$PatientValue ( y ) ∼ {\sum }_{x = 1}^{σ} \frac{DrugValue ( {x}^{′} )}{EnrollmentTarget ( {x}^{′} )} \cdot Eligible ( x , y ) \cdot \frac{EnrollmentTarget ( {x}^{′} )}{Total Eligible ( {x}^{′} )}$$

$$PatientValue ( y ) ∼ {\sum }_{x = 1}^{σ} DrugValue ( x ) \cdot \frac{Eligible ( x , y )}{Total Eligible ( x )}$$

$$PatientValue ( y ) ∼ {\sum }_{x = 1}^{σ} Prevalence ( x ) \cdot PerPatientProfit ( x ) \cdot \frac{Eligible ( x , y )}{Total Eligible ( x )}$$

$$PatientValue ( y ) ∼ {\sum }_{x = 1}^{σ} Prevalence ( x ) \cdot PerPatientProfit ( x ) \cdot \frac{Eligible ( x , y )}{{\sum }_{i = 1}^{p} Eligible ( x , i )}$$

In some embodiments where more than one method or algorithms are used for identified qualified patients for clinical trials, the program(s) of the systems described herein can further comprise instructions for ranking the efficiency of the methods or algorithms used for identifying the qualified patient for the clinical trials. In some embodiments, depending on the recruitment strategy, the selected method or algorithm can be used to identify patients for determination of their values using the systems described herein.

In some embodiments, by adjusting or optimizing one or more parameters involved in the determination of the patient values (e.g., but not limited to, patient compensation, drug value, eligibility criteria, enrollment target size, expected patient enrollment costs associated with identifying qualified patients, expected efficiencies of identifying qualified patients, expected time cost, and/or any combinations thereof), the patient values can be changed accordingly. Thus, in some embodiments, the systems described herein can further be programmed to minimize overall cost of selecting the study subjects for one or more clinical trials, e.g., by optimizing one or more parameters involved in determination of patient values as described herein.

Identifying Qualified Patients for Clinical Trials:

In some embodiments, the instructions can further comprise searching at least one database comprising the patient profiles to identify the qualified patients, prior to computing or determining patient values as described herein. For example, a patient's chart or electronic health records (EHRs) can be queried and/or compared to eligibility criteria (including inclusion and exclusion criteria) for a clinical trial.

In some embodiments, the database can comprise a first database and a second database, wherein the first database comprises the patient profiles, and the second database comprises data associated with eligibility criteria of the clinical trials. In some embodiments, at least one database can be stored in a remote computer system over a network. In some embodiments, at least one database can be stored locally in the computer system. In some embodiments, the systems described herein can be further programmed to comprise instructions for connecting the computer system to at least one database, e.g., patient profile database and/or clinical trial database.

In some embodiments, the qualified patients can be identified by comparing, for each patient in the patient population, a feature set associated with the patient (or patient profile) to the eligibility criteria of the clinical trials, wherein the feature set comprises at least demographic features of the patient. Examples of the demographic features include, but are not limited to, gender, age, ethnicity, knowledge of languages, disabilities, mobility, home ownership, employment status, and location, and any combinations thereof.

In some embodiments, the feature set associated with each patient (or patient profile) can further comprise information associated with the patient's diagnosis, procedures, laboratory measurements and/or test results, medications prescribed, or any combinations thereof. In some embodiments relating to medications prescribed, policies such as medication reconciliation can be adopted to improve the accuracy of the data in a hospital's HER. The term “medication reconciliation” is known to refer to a formal process for creating the most complete and accurate list possible of a patient's current medications and comparing the list to those in the patient record or medication orders. According to the medication reconciliation policy, a comprehensive list of medications should include all prescription medications, herbals, vitamins, nutritional supplements, over-the-counter drugs, vaccines, diagnostic and contrast agents, radioactive medications, parenteral nutrition, blood derivatives, and intravenous solutions. See, e.g., Barnsteiner JH. Medication Reconciliation. In: Hughes RG, editor. Patient Safety and Quality: An Evidence-Based Handbook for Nurses. Rockville (Md.): Agency for Healthcare Research and Quality (US); 2008 April Chapter 38, for additional information about medication reconciliation.

In some embodiments, the patient profile database and the clinical trial database can express diseases and/or conditions in different controlled medical vocabularies included within the Unified Medical Language System (UMLS), e.g., but not limtied to, Medical Subject Headings (MeSH) and International Classification of Diseases (ICD). In these embodiments, information expressed in one medical vocabulary can be mapped or converted to another medical vocabulary for matching the right patients to clinical trials.

In some embodiments, the feature set associated with each patient (or patient profile) can further comprise information associated with vital status (e.g., date of birth/death), vital signs (e.g., blood pressure and/or heart rate), allergies, immunizations, physical exams, and any combinations thereof.

In some embodiments, the feature set associated with each patient (or patient profile) can further comprises the patient's family history, social history or environment-associated history, psychiatric history, or any combinations thereof.

In some embodiments, the feature set associated with each patient (or patient profile) can further comprise the patient's usage of social media including usage frequency and content distributed in the social media. Their e-personality can contribute to determination of their appropriateness to a given clinical trial.

Some of the patient profile data, e.g., data displayed as patient notes, diagnosis images and signals (e.g., but not limited to, radiology images, electrocardiograms, angiograms, CT scans, and/or MRI images) and other types of non-coded data, can be converted into codes that can be queried, e.g., by the SHRINE and/or i2b2 platforms, for identifying qualified patients for clinical trials. Any art-recognized natural language processing (NLP), image processing, and signal processing methods can be used to convert non-coded data into coded data. An example NLP program that can be used to extract information from clinical text is clinical Text Analysis and Knowledge Extraction System (cTAKES), which, for example, can process clinical notes, identifying types of clinical named entities from various dictionaries including the Unified Medical Language System (UMLS)—medications, diseases/disorders, signs/symptoms, anatomical sites and procedures. Additional information about cTAKES can be accessible at http://ctakes.apache.org and found in Savova et al. “Mayo clinical Text Analysis and Knowledge Extraction System (cTAKES): architecture, component evaluation and applications” J Am Med Inform Assoc 2010; 17:507-513, the contents of each of which are incorporated herein by reference.

Developing sophisticated NLP algorithms can require both significant human and computational resources, which might be more expensive than simply having a physician manually read and code the notes. Such algorithms can be desired to be applied for large populations or recurrent characteristics that are require across multiple drug trials. However, once an algorithm is developed for one trial (e.g., NLP to determine tobacco use), it can be used for other clinical trials. For small and one-off trials, it may be less expensive to screen patients through phone calls than manually reviewing their data before contacting them to eliminate false matches.

Methods or algorithms used for identifying qualified patients for clinical trials are known in the art and can be used for the purposes described herein. In some embodiments, these methods or algorithms can be incorporated into the systems described herein. For example, a shared health research information network (SHRINE) has been previously developed to enable research queries across the full patient populations of more than one hospital. The SHRINE uses a federated architecture, where each hospital can return only the aggregate count of the number of patients who match a query. This can allow hospitals to retain control over their local databases and comply with federal and state privacy laws. See, e.g., Weber GM., J Am Med Inform Assoc (2013) 20(el): e155-161; McMurry et al. PLoS One (2013) 8: e55811; and Weber et al., J Am Med Inform Assoc (2009) 16: 624-630 for descriptions of the SHRINE system structures and uses thereof.

In some embodiments, Informatics for Integrating Biology and the Bedside (i2b2) platform can be employed and/or incorporated into the systems described herein to integrate medical record and clinical research data and/or to find sets of qualified patients from electronic health records data, while preserving patient privacy through a query tool interface. Project-specific mini-databases can be created from these sets to make detailed data available on these specific qualified patients to the investigators on the i2b2 platform. See, e.g., Murphy et al., J Am Med Inform Assoc (2010) 17: 124-130 for description of i2b2 system.

In some embodiments, registries, a well-established mechanism for obtaining disease-specific data on distinct cohorts of subjects with preselected diseases, environmental exposures and/or treatments of interest, can be employed and/or incorporated into the systems described herein to identify qualified patients from electronic health record data. See, e.g., Gliklich and Dreyer, AHRQ Publication No. 07-EHC001-1. Rockville, Md.: Agency for Healthcare Research and Quality, April 2007 for additional information on Registries for evaluating patient outcomes and uses thereof. In some embodiments, a self-scaling registry technology for collaborative data sharing, e.g., based on the i2b2 data warehouse framework and the SHRINE peer-to-peer networking software as described in Natter et al., J Am Med Inform Assoc (2013) 20: 172-179, can be employed and/or incorporated into the systems described herein to identify qualified patients from electronic health record data. In some embodiments, a combination of coded data from electronic medical records (EMRs) and analysis of clinical notes, e.g., using NLP, can be used to identify patients qualified for the clinical trials. See, e.g., Liao et al. “Electronic medical records for discovery research in rheumatoid arthritis” Arthritis Care Res (Hoboken) 2010; 62(8): 1120-1127, for using a classification algorithm incorporating narrative EMR data (types physician notes) into codified EMR data to classify subjects with a specific profile or disease. In some embodiments, the ib2b platform can be used to identify patients who are qualified for clinical trials. See, e.g., Murphy et al. “Instrumenting the health care enterprise for discovery research in the genomic era” Genome Res. 2009; 360: 1675-1681.

The patient profiles can be derived from patient charts and/or electronic health records (EHRs) of the patient population. The EHR data is generally the superposition of both patient pathophysiology and the dynamics of the health care system. For example, a laboratory test result is a direct measurement of the patient, but the physician's decision to order that particular test when she did might be based on many factors such as her subjective assessment of the patient, e.g., whether the patient's insurance covers the test, and/or how long it will take to receive the test results. Table 1 summaries some of the “forces” that drive health care dynamics. These forces are not “noise” that are commonly believed to make EHR data less useful, but rather additional information that can be useful for clinical research if it can be separated from the pathophysiology.

TABLE 1
Forces that drive health care dynamics.

| Force | Features | Example |
|---|---|---|
| Hospital | geographic location, types of | The average age in a pediatric |
| | clinics available, services/ | hospital is younger than the |
| | procedures offered | population average. |
| Physician | training and experience, sub- | A physician orders complete |
| | jective assessment of patient, | blood count (CBC) test, but |
| | differential diagnosis | determines that chemistries |
| | | are not needed. |
| Economic | financial cost/benefit of | Smoking status is recorded |
| | procedures to the hospital, | electronically in order to |
| | patients' insurance | meet meaningful use |
| | | requirements. |
| Patient | compliance, personal beliefs, | A patient does not take a |
| | preferences, access to | medicine that was pre- |
| | healthcare | scribed for her. |

The identified patients as study subjects can be eligible for either a treatment group or a control (normal healthy subjects) group of study. The term “normal healthy subject” generally refers to a subject who has no symptoms of any diseases or disorders, or who is not identified with any diseases or disorders, or who is not on any medication treatment, or a subject who is identified as healthy by physicians based on medical examinations. In a patient population, normality of patients are typically defined as a function of pathophysiology, such as normal height or blood pressure. Normal values are determined by measuring patients in a standardized way in order to calculate unbiased percentiles. However, in an EHR, normality can also be defined in the context of health care dynamics, and abnormality can similarly provide information about a patient's health state. For example, a fact or observation that a patient order a white blood cell (WBC) test at late night, e.g., after the normal business hours of clinics, can be indicative of the patient having a health issue. A simple “biomarker” for health care dynamics is “fact” count. A data fact is any patient observation, such as diagnosis, laboratory test result, medication, or procedure. It can be measured in many ways, such as total number of facts, rate of new facts, time of facts (e.g., weekend or late night facts), location of facts (e.g., ICU or outpatient facts), type of facts (e.g., laboratory test), and time between facts (e.g., time between visits). The health care dynamics can be defined in any appropriate measures based on the types of data available in the EHRs. FIGS. 2A-2D show distributions of some example measures of health care dynamics, including, but not are limited to time of day when white blood cell (WBC) tests are ordered (FIG. 2A), number of days until a WBC test is repeated for the same patient (FIG. 2B), fact count growth chart by age (FIG. 2C), and patient health state by age as defined by diagnosis types and counts (FIG. 2D). Similar to a growth chart for patient height can be drawn, a patient's fact counts can be compared to the distribution of patient fact counts in the entire EHR, and changes can be tracked over time.

In some embodiments, the health care dynamics of EHR can be used to provide information about a patient's health state and/or accuracy or reliability of the health records. For example, in some embodiments, the fact counts can be used to predict length of hospital visit, readmission rates, or life expectancy. In some embodiments, the fact counts can be used to classify diseases as chronic or non-chronic. In some embodiments, the fact counts can be used to measure health care burden. In some embodiments, the fact counts can be used to identify sub-populations of patients who respond differently to treatments. In some embodiments, the fact counts can be used to quantify a patient's overall state of health. In some embodiments, the fact counts can be used to capture physician expertise and generate evidence based guidelines. In some embodiments, the fact counts can be used to identify biases in the codes providers use due to hospital policies. By assessing the health care dynamics in appropriate measures in addition to the patient's pathophysiology, the eligibility of the patients for clinical trials can be further validated.

In some embodiments where the EHR records of patients are incomplete (e.g., due to patients being treated at other facilities, certain types of data not being collected in the HER, providers not entering information into the EHR), information in a patient's chart or clinical notes can be used to estimate the probability that a missing fact does not exist. For example, a patient who lives far from a hospital, a patient having no facts in EHR over an extended period of time, or a patient whose facts in EHR are entirely from a single emergency department visit can indicate that the patient likely has received care from another facility. In some embodiments, heuristic approaches can be used to identify and/or correct missing or incorrect data in the electronic health records. For example, other types of data, e.g., but not limited to claims data, census data, or population data (e.g., social security death index) can be used a training data set to build a model that predicts missing EHR data. In some embodiments, high correlations between different types of facts can be used to complete missing records or identify incorrect data. For example, if a patient's EHR record shows that she is pregnant, the patient with the missing or correct gender information can be assumed to be female.

Normal healthy patients are important as controls in clinical trials. However, identifying normal healthy subjects in an EHR that contains primarily sick hospital patients can be challenging. For example, the absence of a data fact, such as a diagnosis, in one EHR, does not necessarily mean that the patient does not have the disease. The missing data could be, for example, due to the patient having diagnosis and receiving treatment at another health care facility. As such, when identifying normal healthy subjects as control study subjects from EHRs, in some embodiments, some factors for consideration can include, but are not limited to, patients' normal pathophysiology data (e.g., whether the patients have any chronic diseases or abnormal lab results); EHR data facts following the health care dynamics of a healthy patient (e.g., routine outpatient visits, no extended inpatient stays); the completeness of patients' health record (e.g., patients with a chronic disease are unlikely being treated at another hospital), and any combinations thereof.

In some embodiments, the health care dynamics of EHRs can be used to identify normal healthy subjects. For example, in some instances where the health records of patients appear to be normal, a data fact (e.g., time, place, and frequency) or patient observation, such as diagnosis, laboratory test result, medication, or procedure can be further analyzed to identify any abnormality. For example, considering patient A whose record includes a visit to an intensive care unit (ICU), a procedure ordered at abnormal business hours (e.g., 2 am), and a prescription for an experimental drug, and patient B whose record includes an annual outpatient visit to an internist, a lab test ordered during normal business hours (e.g., 2 pm), and a mammogram. While none of these data facts are direct measures of the patients' health, the derivation of patient A's facts from normal health care dynamics more than patient B can indicate that patient B is likely healthier than patient A.

The normal healthy subjects can be a randomly selected control group or matched control group. In some embodiments, the normal healthy subjects are matched control subjects. The term “matched control subjects” refers to subjects whose physical characteristics that can bias the pathophysiology (e.g., but not limited to age, race, and gender) are matched (e.g., same or within 10% for numerical values) to those of study subjects in a treatment group. In some embodiments, the completeness of the matched control subjects' medical records can be matched to those of study subjects in a treatment group.

Additional Exemplary Modifications to Computer Programs to Increase the Accuracy of Patient Value Determination:

Correction of potential errors in identifying qualified patients for clinical trials: In some embodiments, the computer programs can include one or more algorithms to correct potential errors in identifying qualified patients for clinical trials. The errors in matching patients to clinical trials can be, e.g., caused by the enrollment criteria not being mapped exactly to the codes in an electronic health record (EHR), EHR codes not reflecting the patient's true health status (e.g., hospitals requiring physicians to use certain codes in order to receive reimbursements), and/or some data being missing (e.g., the patient may also receive care at another hospital). These potential errors, which can increase patient enrollment costs, can be categorized into two types: (i) False matches or Type I error; and (ii) False non-matches or Type II error. False matches, or Type I error refers to an error in which patients are incorrectly selected by the algorithm and are later discovered during screening to not be eligible for the clinical trial. Type I error reduces the yield of patient recruitment and increases enrollment costs because money is wasted contacting and screening patients who are actually not eligible for the trial. False non-matches, or Type II error refers to an error in which patients are incorrectly determined by the algorithm as not being eligible for the trial. Type II error decreases the supply of the qualified patients and increases enrollment costs by slowing the rate at which eligible patients can be found. The longer it takes to reach the target enrollment numbers, the more it costs to keep the study active, and/or the longer it takes for the medical intervention to reach the market, which results in its manufacturer losing potential sales before the patent for the drug expires.

Accordingly, in some embodiments, the system can be specifically programmed to minimize false matches or Type I error, and/or false non-matches or Type II error. By way of example only, in some embodiments, the system can be programmed to modify the search criteria. For example, when searching for patients with diabetes, one can reduce false matches (Type I error) by requiring both a diabetes diagnosis AND a prescription for insulin; and/or reduce false non-matches (Type II error) by requiring either a diabetes diagnosis OR a prescription for insulin.

In some embodiments, the Eligibilityₓ in Correlation (1) or (2) can be corrected by a factor of a positive predictive value (defined as a ratio of true matches (TM) to a total of true matches (TM) and false matches (FM) as shown in FIG. 1) to account for false matches or type I errors. In some embodiments, the Eligibilityₓ in Correlation (1) or (2) can be corrected by a factor of sensitivity (defined as a ratio of true matches (TM) to a total of true matches (TM) and false non-matches (FN) as shown in FIG. 1) to account for false non-matches or type II errors.

While not necessary, in some embodiments, a skilled artisan can manually review all matches before determining the values of identified qualified patients, which can, for example, reduce the number of false matches (Type 1 error) and/or increase the number of false non-matches (Type II error).

In some embodiments, the system can be programmed to increase the accuracy and/or completeness of electronic health records. For example, heuristic approaches can be used to correct missing or incorrect data in the electronic health records. In some embodiments, other types of data, e.g., but not limited to claims data, census data, or population data (e.g., social security death index) can be used a training data set to build a model that predicts missing EHR data. By way of example only, a patient with a missing information on gender can be assumed to be female when her medical or health records showed that she gave birth to a child. A patient whose age in record is 150 years old can be assumed to be incorrect.

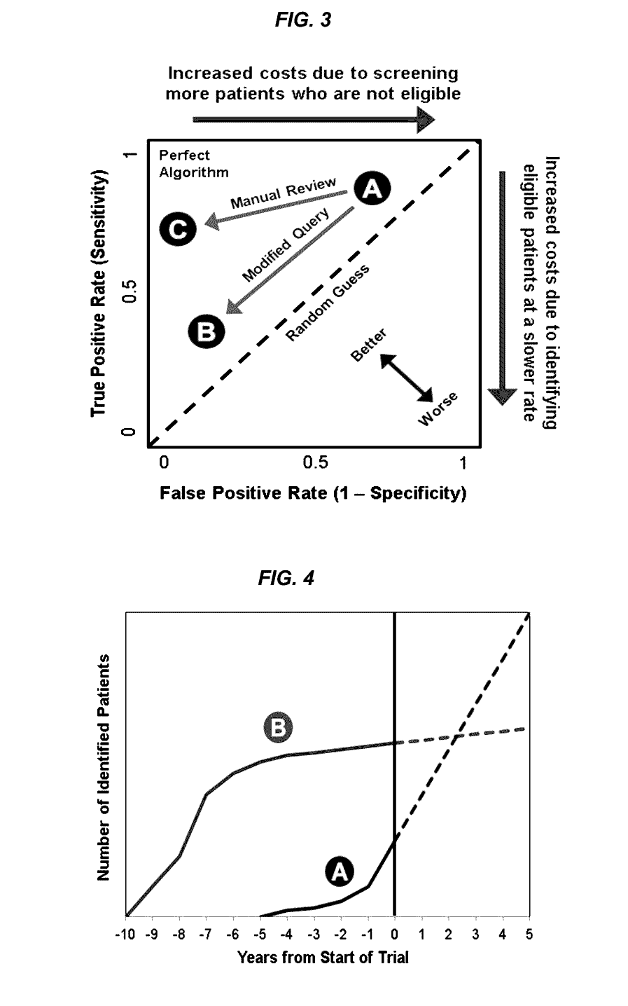

In some embodiments, the system can employ more than one algorithm to identify qualified patients for clinical trials. By way of example only, as shown in FIG. 3, one can employ an algorithm “A” that has high sensitivity (e.g., matches most eligible patients); an algorithm “B” that has high specificity (few false matches); and an algorithm “C” to reduce the number of false matches (e.g., by manually review the data for patients matched by “A” but not “B”)

Accordingly, in some embodiments, a value (V) can be more accurately computed using the following method (II). Some assumptions made in the method (II) include:
(i) the cost of developing and running the algorithms are negligible;
(ii) all patients identified by the algorithms are willing to participate in the trials. In other words, all contacted patients will volunteer to be screened;
(iii) patients can simultaneously participate in multiple clinical trials. In other words, subjects who participate in one clinical trial does not affect their eligibility for other clinical trials; and
(iv) there is only one health care center.

Let PatentYears(x) be the number of years until the patent for a drug x to be studied in the clinical trial x expires.

Let TrialYears(x) be the expected number of years until the clinical trial x reaches its enrollment target.

Let PerPatientProfit(x) be the amount of profit selling drug x to a single patient per year.

DrugValue(x)˜Prevalence(x)·PerPatientProfit(x)·(PatentYears(x)−TrialYears(x))

Let Algorithms(x) be the number of algorithms developed to identify potential study subjects for clinical trial x.

Let PPV(x,z) be the positive predictive value of algorithm z matching patients to clinical trial x.

Let Eligible(x,y,z) (i.e., Eligibilityₓ) be 1 if patient y is found to be a new potential subject for trial x by algorithm z in the current year, and 0 otherwise.

Let TotalEligible(x) (i.e., Supplyₓ) be the total number of new potential patients who are eligible for clinical trial x in the current year.

$$Total Eligible ( x ) = {\sum }_{y = 1}^{p} max Eligible ( x , y , z )$$

Let BestPPV(x,y) be the best positive predictive value (PPV) of any algorithm that identifies patient y as a study subject for the clinical trial x.

$$BestPPV ( x , y ) = {max}_{1 \leq e \leq Algorithms ( x )} ( Eligible ( x , y , z ) \cdot PPV ( x , ) )$$

Let TotalEnrolled(x) be the total number of new patients expected to be enrolled in clinical trial x in the current year, given the fact that some patients will not pass screening.

$$TotalEnrolled ( x ) ∼ {\sum }_{y = 1}^{P} BestPPV ( x , y )$$

This can be used to redefine ChanceSelected(x,y).

$$ChanceSelected ( x , y ) ∼ Eligible ( x , y ) \cdot min ( \frac{EnrollmentTarget ( x )}{TotalEnrolled ( x )} , 1 )$$

The TrialYears(x) can also be estimated in terms of the enrollment target and the expected number of new patients enrolled per year. The TrialYears(x) can be estimated by any methods known in the art. For example, the TrialYears(x) can also be determined by estimating the enrollment rate of an algorithm used to identify new patients for a clinical trial as described in the subsection below.

$$TrialYears ( x ) ∼ \frac{EnrollmentTarget ( x )}{TotalEnrolled ( x )}$$

The PerSubjectValue(x) (i.e. Compₓ) can also be redefined in terms of the expected trial years.

$$PerSubjectValue ( x ) ∼ \frac{DrugValue ( x )}{EnrollmentTarget ( x )}$$

$$PerSubjectValue ( x ) ∼ \frac{\begin{matrix}Prevalence ( x ) \cdot PerPatientProfit ( x ) \cdot \\ ( PatentYears ( x ) - TrialYears ( x ) )\end{matrix}}{EnrollementTarget ( s )}$$

Let ScreeningCost(x) be the cost to screen one patient for clinical trial x. The screening cost per patient can include the cost of patients who are eligible but cannot be recruited.

Let ValueToTrial(x,y) (i.e., Vx (patient y)) be the expected value of patient y to trial x. All eligible patients who are selected for screening will require the screening cost to be spent; however, only the ones that pass screening (the probability of which is BestPPV(x,y)) will be valuable as a study subject.

$$ValueToTrial ( x , y ) ∼ ( PerSubjectValue ( x ) \cdot ( BestPPV ( x , y ) - ScreeningCost ( x ) ) \cdot ChanceSelected ( x , y )$$

Let PatientValue(y) (i.e., V(patient y)) be the total expected value of patient y across all c clinical trials.

$$PatientValue ( y ) ∼ {\sum }_{x = 1}^{e} ValueToTrial ( x , y )$$

One or more assumptions made in the method (II) for estimating patient value can be relaxed by modifying one or more equations as described above. For example, if the costs of developing and running the algorithms for identifying qualified patients are significant (e.g., there is a manual component), then this cost can be subtracted from the potential drug value. If few patients who are contacted are willing to be screened, then (1) the PPV of the algorithms for identifying qualified patients can be decreased since fewer patients will be enrolled, and/or (2) the average screening cost can be decreased since many of the patients who are contacted will not need to be fully screened. If a patient participating in one clinical trial cannot be recruited for another clinical trial, then the value of the patient can be less than the sum of the patient's values to individual trials when determined independently. If there are multiple health care centers, then a health care center's patients are only valuable for the clinical trial x if it is more expensive to reach the enrollment targets for the clinical trial x by enrolling patients from other health care centers. Therefore, if a health care center is determining the value of its patients, the health care center should only consider clinical trials for which it thinks it has better algorithms for identifying qualified patients or more patients than other health care centers.

Rate of Patient Enrollment to Clinical Trials:

In some embodiments, the system can be programmed to estimate the enrollment rate of an algorithm used to identify new qualified patients. In some embodiments, the enrollment rate of an algorithm can be estimated by first calculating the number of patients it identifies using all currently available data, and then calculating the number of patients it identifies based only on data available through some date in the past. The difference predicts the number of future patients the algorithm will identify. However, this estimation method may not reflect the actual number of identified new patients because EHRs evolve over time (FIG. 4). It typically takes a few years for a new data type to be fully incorporated into the EHR. As a result, an algorithm that uses a newly added data type might be less predictable than another algorithm that uses codes where the number of new patients has grown at a stable rate for several years. This uncertainty in whether the algorithm can actually achieve its predicted enrollment rate can increase the estimated enrollment costs.

Prior experience of a hospital in enrolling patients into previous clinical trials can help predict the enrollment rate for a new clinical trial. For example, a hospital might have previously had more difficulty in enrolling patients of certain characteristics, e.g., but not limited to, ages, races, and/or ethnicities.

The determined values of patients can change over time. For example, as more data becomes available about patients, the clinical trials they are eligible for may change. The types of medical interventions that are high priority for companies and funding agencies may change over time. Patients being contacted by clinical trials may stop responding. By enrolling in one clinical trial, a patient may no longer be eligible for another. As a clinical trial progresses, the collected data may help researchers or companies to better identify patients who are likely to pass screening, thus lowering patient enrollment costs.

The display module 610 enables display of a content 608 based in part on the analysis result for the user, wherein the content 608 is a signal indicative of information associated with at least a subset of the patient population, wherein the signal is selected from the group consisting of a signal indicative of ranking of at least a subset of the patient population, a signal indicative of values of at least a subset of the patient population, a signal indicative of at least of a subset of the patient population selected for the clinical trial, a signal indicative of no patient selected for the clinical trial, and any combination thereof.

For example, based on the patient values determined in the analysis module, the display module 610 can display a content indicative of ranking of at least a subset of the patient population, e.g., high value patients. In some embodiments, the values of the patients can be displayed. In some embodiments, the content can display a set of qualified patients for the clinical trial (not necessarily in the order of patient values). The qualified patients can be either in a test or a control group of a treatment to be studied in a clinical trial. The control group can be matched to the test group, e.g., based on physiological characteristics.

The signal can be provided via any suitable display means, including, but not limited to, a computer display, a screen, a monitor, an email, a text message, a webstite, a physical printout (e.g., but not limited to paper), or be provided as stored information in a storage device.

The signal can be used in a decision making process, for example, but not limited to, for identifying high value patients or other matter relating to high value patients. In some embodiments, the high value patients can be selected based on a human evaluation of the signal. By identifying high value patients, for example, hospitals can invest their resources to high value patients, e.g., to review the quality (e.g., accuracy and/or completeness) of their health records, to enter them into registries, and/or to ensure their contact information is accurate before they are needed for a clinical trial.

In some embodiments, the signal can be further processed, analyzed and/or evaluated to facilitate companies and non-profits involved in clinical trials recruitment to better allocate resources in clinical trials. For example, the signal can be further processed, analyzed and/or evaluated to determine which clinical trial the patients should participate in. Therefore, a hospital can set a price on its patients to drug companies, e.g., based on the values computed for the patients. A drug company can optimize their recruiting strategy for a clinical trial; estimate the cost of patient recruitment for a clinical trial; and/or determine an optimum study population for a clinical trial. For example, by analyzing the effects of at least one or more parameters involved in determination of the patient values described herein on the values of the patients, a drug company can, for example, modify the eligibility criteria for the clinical trial to optimize the cost and/or time for patient recruitment.

A tangible and non-transitory (e.g., no transitory forms of signal transmission) computer readable medium having computer readable instructions recorded thereon to define software modules for implementing a method on a computer is also provided herein. In one embodiment, the computer readable storage medium comprises: instructions for:

a) computing, for each patient in a patient population, a value as a function of parameters comprising:

i. supply of qualified patients for at least a subset of clinical trials, wherein said each patient is qualified for the at least a subset of the clinical trials; and wherein the supply of the qualified patients is identified based on patient profiles and eligibility criteria of the clinical trials;

ii. demand for study subjects of the at least a subset of the clinical trials; wherein the value provides a relative ranking of said each patient to other patients in the patient population or a relative value of said each patient to a pre-determined threshold; and

b) displaying a content that comprises a signal indicative of information associated with at least a subset of the patient population, wherein the signal is selected from the group consisting of a signal indicative of ranking of at least a subset of the patient population, a signal indicative of values of at least a subset of the patient population, a signal indicative of at least of a subset of the patient population selected for the clinical trial, a signal indicative of no patient selected for the clinical trial, and any combination thereof.

The content can be a signal indicative of information associated with at least a subset of the patient population, wherein the signal is selected from the group consisting of a signal indicative of ranking of at least a subset of the patient population, a signal indicative of values of at least a subset of the patient population, a signal indicative of at least of a subset of the patient population selected for the clinical trial, a signal indicative of no patient selected for the clinical trial, and any combination thereof. For example, based on the patient values determined in the analysis module, the content can display a ranking of at least a subset of the patient population, e.g., high value patients. In some embodiments, the values of the patients can be displayed. In some embodiments, the content can display a set of qualified patients for the clinical trial (not necessarily in the order of patient values). The qualified patients can be either in a test or a control group of a treatment to be studied in a clinical trial. The control group can be matched to the test group, e.g., based on physiological characteristics.

Embodiments of the systems described herein are described through functional modules, which are defined by computer executable instructions recorded on computer readable media and which cause a computer to perform method steps when executed. The modules have been segregated by function for the sake of clarity. However, it should be understood that the modules need not correspond to discrete blocks of code and the described functions can be carried out by the execution of various code portions stored on various media and executed at various times. Furthermore, it should be appreciated that the modules may perform other functions, thus the modules are not limited to having any particular functions or set of functions.

The computer readable media can be any available tangible media that can be accessed by a computer. Computer readable media includes volatile and nonvolatile, removable and non-removable tangible media implemented in any method or technology for storage of information such as computer readable instructions, data structures, program modules or other data. Computer readable media includes, but is not limited to, RAM (random access memory), ROM (read only memory), EPROM (erasable programmable read only memory), EEPROM (electrically erasable programmable read only memory), flash memory or other memory technology, CD-ROM (compact disc read only memory), DVDs (digital versatile disks) or other optical storage media, magnetic cassettes, magnetic tape, magnetic disk storage or other magnetic storage media, other types of volatile and non-volatile memory, and any other tangible medium which can be used to store the desired information and which can accessed by a computer including and any suitable combination of the foregoing.

In some embodiments, the system 600 and/or computer readable storage media 700 can include the “cloud” system, in which a user can store data on a remote server, and later access the data or perform further analysis of the data from the remote server.

Computer-readable data embodied on one or more computer-readable media, or computer readable medium 700, may define instructions, for example, as part of one or more programs, that, as a result of being executed by a computer, instruct the computer to perform one or more of the functions described herein (e.g., in relation to system 600, or computer readable medium 700), and/or various embodiments, variations and combinations thereof. Such instructions may be written in any of a plurality of programming languages, for example, Java, J#, Visual Basic, C, C#, C++, Fortran, Pascal, Eiffel, Basic, COBOL assembly language, and the like, or any of a variety of combinations thereof. The computer-readable media on which such instructions are embodied may reside on one or more of the components of either of system 600, or computer readable medium 700 described herein, may be distributed across one or more of such components, and may be in transition there between.

The computer-readable media can be transportable such that the instructions stored thereon can be loaded onto any computer resource to implement the program(s) and instructions described herein. In addition, it should be appreciated that the instructions stored on the computer readable media, or computer-readable medium 700, described above, are not limited to instructions embodied as part of an application program running on a host computer. Rather, the instructions may be embodied as any type of computer code (e.g., software or microcode) that can be employed to program a computer to implement the program(s) and instructions described herein. The computer executable instructions may be written in a suitable computer language or combination of several languages.

The functional modules of certain embodiments of the system described herein can include a storage device, an analysis module and a display module. The functional modules can be executed on one, or multiple, computers, or by using one, or multiple, computer networks.

As used herein, “stored” refers to a process for encoding information on the storage device 604. Those skilled in the art can readily adopt any of the presently known methods for recording information on known media.

A variety of software programs and formats can be used to store the identified patient profiles and/or determined patient values on the storage device. Any number of data processor structuring formats (e.g., text file or database) can be employed to obtain or create a medium having recorded thereon the determined patient values.

In one embodiment, the storage device 604 can be read by the analysis module 606 and store data determined from the analysis module 606. For example, in some embodiments, the storage device 604 can store profiles of identified patients for various clinical trials. In some embodiments, the storage device can store computed or determined patient values from the analysis module 606.

The “analysis module” 606 can use a variety of available software programs and formats for computing values of patients in a patient population. In some embodiments, the analysis module can further comprise software programs comprising instructions for identifying qualified patients for clinical trials from electronic health records prior to the patient value determination. In some embodiments, the analysis module can further comprise software programs comprising instructions for ranking the patients in a patient population or categorizing the patients into different groups based on the determined patient values.

The analysis module 606, or any other module of the system described herein, may include an operating system (e.g., UNIX) on which runs a relational database management system, a World Wide Web application, and a World Wide Web server. World Wide Web application includes the executable code necessary for generation of database language statements (e.g., Structured Query Language (SQL) statements). Generally, the executables will include embedded SQL statements. In addition, the World Wide Web application may include a configuration file which contains pointers and addresses to the various software entities that comprise the server as well as the various external and internal databases which must be accessed to service user requests. The Configuration file also directs requests for server resources to the appropriate hardware—as may be necessary should the server be distributed over two or more separate computers. In one embodiment, the World Wide Web server supports a TCP/IP protocol. Local networks such as this are sometimes referred to as “Intranets.” An advantage of such Intranets is that they allow easy communication with public domain databases residing on the World Wide Web. Thus, in a particular embodiment, users can directly access data (via Hypertext links for example) residing on Internet databases using a HTML interface provided by Web browsers and Web servers. In another embodiment, users can directly access data residing on the “cloud” provided by the cloud computing service providers.

The analysis module 606 provides computer readable analysis result that can be processed in computer readable form by predefined criteria, or criteria defined by a user, to provide a content based in part on the analysis result that may be stored and output as requested by a user using a display module 610. The display module 610 enables display of a content 608 based in part on the analysis result for the user, wherein the content 608 is a signal indicative of information associated with at least a subset of the patient population, wherein the signal is selected from the group consisting of a signal indicative of ranking of at least a subset of the patient population, a signal indicative of values of at least a subset of the patient population, a signal indicative of at least of a subset of the patient population selected for the clinical trial, a signal indicative of no patient selected for the clinical trial, and any combination thereof.

For example, based on the patient values determined in the analysis module, the display module 610 can display a content indicative of ranking of at least a subset of the patient population, e.g., high value patients. In some embodiments, the values of the patients can be displayed. In some embodiments, the content can display a set of qualified patients for the clinical trial (not necessarily in the order of patient values). The qualified patients can be either in a test or a control group of a treatment to be studied in a clinical trial. The control group can be matched to the test group, e.g., based on physiological characteristics.

In one embodiment, the content 608 based on the analysis result is displayed on a computer monitor. In one embodiment, the content 608 based on the analysis result is displayed through printable media. The display module 610 can be any suitable device configured to receive from a computer and display computer readable information to a user. Non-limiting examples include, for example, general-purpose computers such as those based on Intel PENTIUM-type processor, Motorola PowerPC, Sun UltraSPARC, Hewlett-Packard PA-RISC processors, any of a variety of processors available from Advanced Micro Devices (AMD) of Sunnyvale, Calif., or any other type of processor, visual display devices such as flat panel displays, cathode ray tubes and the like, as well as computer printers of various types.

In one embodiment, a World Wide Web browser is used for providing a user interface for display of the content 608 based on the analysis result. It should be understood that other modules of the system described herein can be adapted to have a web browser interface. Through the Web browser, a user may construct requests for retrieving data from the analysis module. Thus, the user will typically point and click to user interface elements such as buttons, pull down menus, scroll bars and the like conventionally employed in graphical user interfaces. The requests so formulated with the user's Web browser are transmitted to a Web application which formats them to produce a query that can be employed to extract the pertinent information related to the selection of patients for clinical trials, e.g., display of ranking of at least a subset of the patient population, e.g., high value patients. In some embodiments, the values of the patients can be displayed. In some embodiments, the content can display a set of qualified patients for the clinical trial (not necessarily in the order of patient values).

In one embodiment, the content 608 based on the analysis result is displayed on a paper.

In any embodiments, the analysis module can be executed by a computer implemented software as discussed earlier. In such embodiments, a result from the analysis module can be displayed on an electronic display. The result can be displayed by graphs, numbers, characters or words, e.g., depending on the labels used to identify patients. In additional embodiments, the results from the analysis module can be transmitted from one location to at least one other location. For example, the comparison results can be transmitted via any electronic media, e.g., internet, fax, phone, a “cloud” system, and any combinations thereof. Using the “cloud” system, users can store and access personal files and data or perform further analysis on a remote server rather than physically carrying around a storage medium such as a DVD or thumb drive.

The system 600, and computer readable medium 700, are merely illustrative embodiments, e.g., for identifying high value patients and/or selecting patients for one or more clinical trials and/or for use in the methods of various aspects described herein and is not intended to limit the scope of the inventions described herein. Variations of system 600, and computer readable medium 700, are possible and are intended to fall within the scope of the inventions described herein.

The modules of the machine, or used in the computer readable medium, may assume numerous configurations. For example, function may be provided on a single machine or distributed over multiple machines.

### Exemplary Applications of the Systems, Computer-Implemented Methods, and Non-Transitory Computer-Readable Storage Media Described Herein

The systems, methods and non-transitory computer-readable storage media described herein can be used to systematically and formally evaluating patients of value in ways that can have considerable effect on the bottom line of companies and non-profits involved in clinical trials recruitment.

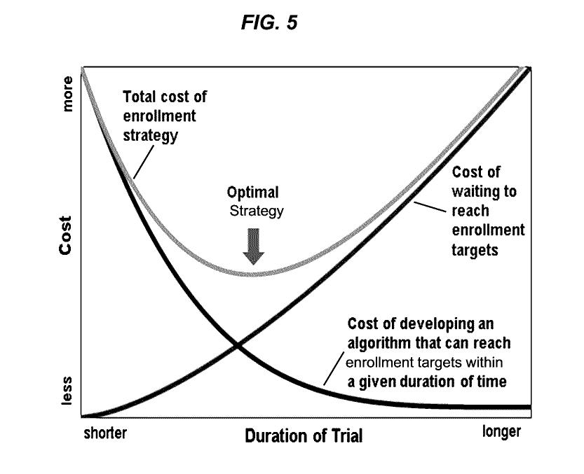

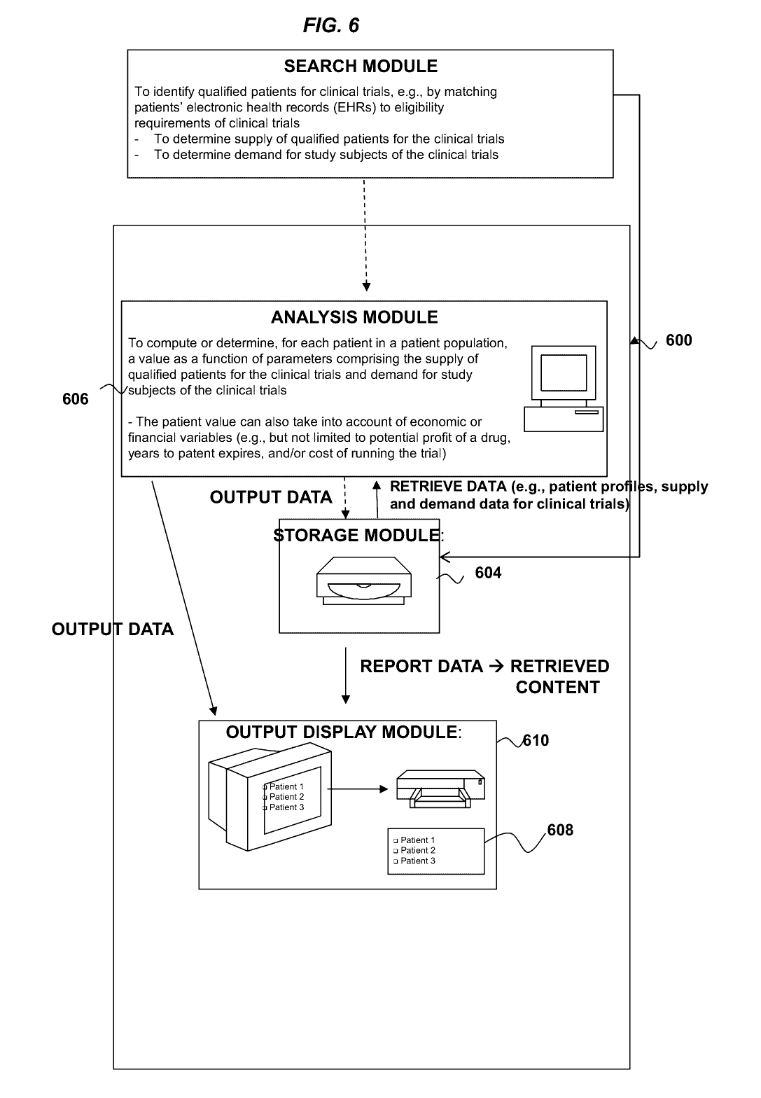

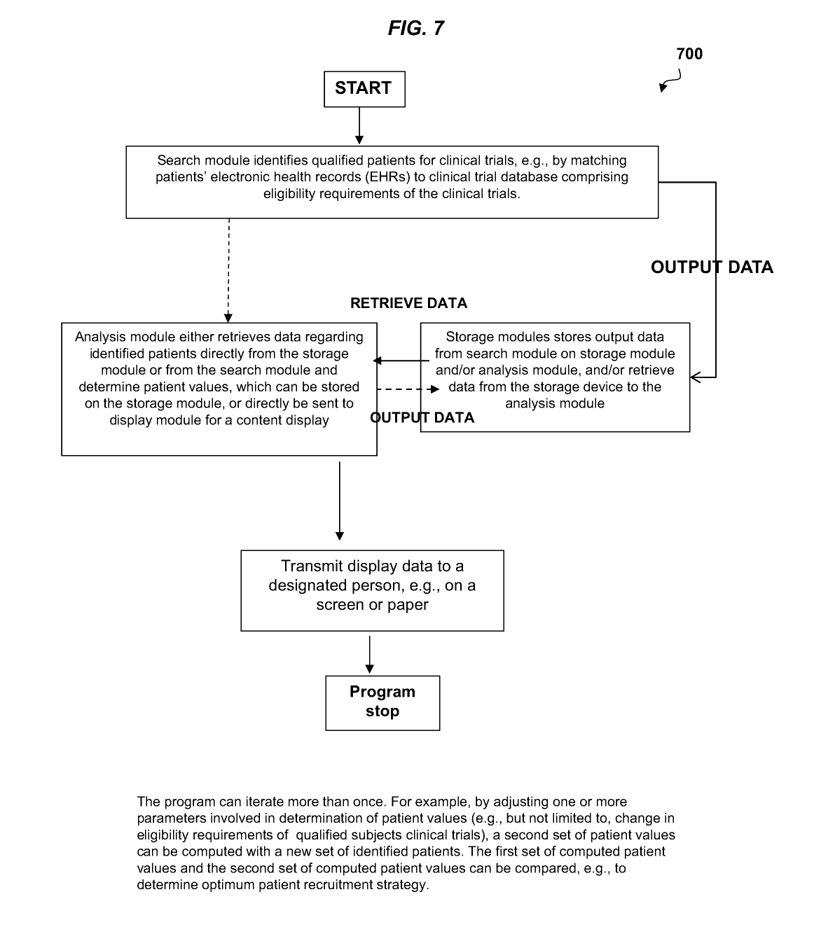

Recruiting patients faster for clinical trials can cost more, but the sooner the enrollment targets are met, the fewer sales of a drug would be lost due to delays in completing the clinical trials. The balance of these two factors sets the cost of patient recruitment that drug manufacturers or companies would pay for (FIG. 5). In some embodiments, by adjusting or optimizing one or more parameters involved in the determination of the patient values (e.g., but not limited to, patient compensation, drug value, eligibility criteria, enrollment target size, expected patient enrollment costs associated with identifying qualified patients, expected efficiencies of identifying qualified patients, expected time cost, and/or any combinations thereof), the patient values can be changed accordingly. Accordingly, in some embodiments, the pharmaceutical companies can use the determined values of patients to better estimate the cost of enrolling patients in a clinical trial and determine if the clinical trial is feasible. Additionally or alternatively, the pharmaceutical companies can use the systems described herein to determine if modifications to their study designs (e.g., changing inclusion/exclusion eligibility criteria) would reduce the cost of enrolling patients in a clinical trial.

Similarly, hospitals can leverage the systems described herein to determine how much to charge pharmaceutical companies for access to their patient data and to justify those costs (e.g., show how much more expensive it would cost at another hospital that does not have as good data or computational resources). Based on the determined values of patients, hospitals can take actions to increase the value of their patients. For example, hospitals can routinely update the contact information for patients most likely to be eligible for trials or patients with higher values. In some embodiments, hospitals can allocate limited resources (e.g., patients or tissue specimens) to clinical trials for which higher values are determined for their patients.

Based on patient values to the clinical trial, patients can make more informed decisions on whether to participate in a clinical trial or if the compensation for participating in the clinical trial is sufficient. In some embodiments, patients can increase their value, e.g., by enrolling in registries.

In some embodiments, Contract Research Organization (CRO) can employ the systems described herein to provide patient suppliers (e.g., hospitals) with their patient valuation in order to maximize the efficiency and dollar values of patient allocation. In some embodiments, using the patient values determined from the systems described herein, the CRO can negotiate with pharmaceutical companies/drug manufacturers regarding identifying high value patients and the sources of such patients.

In some embodiments, investors and/or analysts can evaluate the worth value of companies or drugs based on the patient valuation determined from the systems described herein.

Embodiments of Various Aspects Described Herein can be Defined in any of the Following Numbered Paragraphs:
1. A system for selecting study subjects for at least one clinical trial comprising: a computer system comprising one or more processors; and memory to store one or more programs, the one or more programs comprising instructions for:
   i. computing, for each patient in a patient population, a value as a function of parameters comprising:
      a. supply of qualified patients for at least a subset of clinical trials, wherein said each patient is qualified for the at least a subset of the clinical trials; and wherein the supply of the qualified patients is identified based on patient profiles and eligibility criteria of the clinical trials;
      b. demand for study subjects of the at least a subset of the clinical trials; and
   ii. displaying a content that comprises a signal indicative of information associated with at least a subset of the patient population, wherein the signal is selected from the group consisting of a signal indicative of ranking of at least a subset of the patient population, a signal indicative of values of at least a subset of the patient population, a signal indicative of at least a subset of the patient population selected for the clinical trial, a signal indicative of no patient selected for the clinical trial, and any combination thereof,
thereby selecting patients of high value as study subjects for the at least one clinical trial
2. The system of paragraph 1, wherein the patients of high value can be selected based on the values computed for the patients.
3. The system of paragraph 1 or 2, wherein the parameters for computing the value of the each patient further comprises an expected screening cost associated with identifying the qualified patient, an expected efficiency of identifying the qualified patient, an expected time cost associated with duration of the clinical trials, or any combinations thereof.
4. The system of paragraph 3, wherein the expected efficiency of identifying the qualified patient is characterized by sensitivity, specificity, and/or positive predictive value of at least one method used for identifying the qualified patient for the clinical trials.
5. The system of paragraph 4, further comprising ranking the at least one method used for identifying the qualified patient for the clinical trials.
6. The system of any of paragraphs 2-5, further comprising optimizing the expected screening cost, the expected efficiency of identifying the qualified patient, and/or the expected time cost.
7. The system of any of paragraphs 2-6, wherein the expected time cost is associated with the number of years remaining between completion of the clinical trial and expiration of a patent for a drug to be studied in the clinical trial.
8. The system of paragraph 6 or 7, wherein the optimization is performed to minimize overall cost of selecting the study subjects for the at least one clinical trial.
9. The system of any of paragraphs 1-8, wherein the computing step (a) comprises:
   (I) computing, for said each patient in the patient population, a first trial-specific value to a first clinical trial as a function of parameters comprising (i) expected compensation for each study subject (Compₓ₌₁), (ii) eligibility of the patient to the first clinical trial (Eligibilityₓ₌₁); (iii) demand for study subjects in the first clinical trial (Demandₓ₌₁); and (iv) supply of qualified patients in the first clinical trial (Supplyₓ₌₁); and
   (II) computing, for said each patient, the value based on at least the first trial-specific value to the first clinical trial computed in (I) and a second trial-specific value of the patient to a second clinical trial.
10. The system of paragraph 9, wherein, for said each patient y, the first trial-specific value to the first clinical trial (Vₓ₌₁) and the second trial-specific value to the second clinical trial (Vₓ₌₂) are each independently computed with the following correlation (1):

$${V}_{x} ( patient\_y ) ∼ {Comp}_{x} * {Eligibility}_{x} * \frac{{Demand}_{x}}{{Supply}_{x}} \qquad Correlation ( 1 )$$

11. The system of paragraph 9 or 10, wherein, for said each patient y, the value (V) is computed with the following correlation (2):

$$V ( patient\_y ) ∼ {\sum }_{x = 1} {Comp}_{x} * {Eligibility}_{x} * \frac{{Demand}_{x}}{{Supply}_{x}} \qquad Correlation ( 2 )$$

12. The system of paragraph 10 or 11, wherein the Eligibilityₓ in Correlation (1) or (2) is corrected by a factor of a positive predictive value.
13. The system of any of paragraphs 10-12, wherein computation of the Vₓ(patient_y) in Correlation (1) includes an expected screening cost associated with identifying the patient, an expected efficiency of identifying the patient, or a combination thereof.
14. The system of any of paragraphs 1-13, further comprising searching at least one database comprising the patient profiles to identify the qualified patients.
15. The system of any of paragraphs 1-14, wherein the patient profiles are derived from electronic health records of the patient population.
16. The system of paragraph 14 or 15, wherein the searching comprises comparing, for each patient in the patient population, a feature set associated with the patient to the eligibility criteria of the clinical trials, wherein the feature set comprises at least demographic features of the patient.
17. The system of paragraph 16, wherein the at least one demographic feature is selected from the group consisting of gender, age, ethnicity, knowledge of languages, disabilities, mobility, home ownership, employment status, and location.
18. The system of paragraph 16 or 17, wherein the feature set further comprises information associated with the patient's diagnosis, procedures, laboratory measurements, medication prescribed or any combinations thereof.
19. The system of any of paragraphs 16-18, wherein the feature set further comprises the patient's family history, environment-associated history, psychiatric history, or any combinations thereof.
20. The system of any of paragraphs 16-19, wherein the feature set further comprises the patient's usage of social media including usage frequency and content distributed in the social media.
21. The system of paragraph 20, wherein electronic personality (e-personality) of the patient contributes to determination of the value of the patient.
22. The system of any of paragraphs 1-21, wherein the value of the each patient corresponds to degree of desirability of the each patient as a study subject in one or more clinical trials.
23. The system of any of paragraph 1-22, wherein the value of the each patient is expressed as a monetary amount of which the patient is worth.
24. The system of any of paragraphs 1-22, wherein the value of the each patient is expressed as an index score relative to other patients.
25. The system of paragraph 24, wherein the index score comprises a number, an alphabet, and/or a word.
26. The system of any of paragraphs 1-25, wherein the value of the each patient is based on a continuous scale.
27. The system of any of paragraphs 1-25, wherein the value of the each patient is based on a discrete scale.
28. The system of any of paragraphs 1-27, wherein the patients of high value are patients that are more desirable than one or more other patients in the population as control subjects or test subjects.
29. The system of any of paragraphs 1-28, wherein the high value patients can have a smaller value than patients that are less desirable as study subjects in a clinical trial.
30. The system of any of paragraphs 1-28, wherein the high value patients can have a higher value than patients that are less desirable as study subjects in a clinical trial.
31. The system of any of paragraphs 1-28, wherein, the high value patients can have a monetary worth value in at least the 70% percentile or higher.
32. The system of any of paragraphs 1-31, wherein the patients of high value selected for the at least one clinical trial are control subjects.
33. The system of any of paragraphs 1-31, wherein the patients of high value selected for the at least clinical trial are test subjects for a treatment with a drug to be studied in the clinical trial.
34. The system of any of paragraphs 1-33, wherein the patients of high value are selected from the following patients:
   i. patients who meet the eligibility criteria for a control or test group of a treatment that is being studied by more than one or multiple clinical trials;
   ii. patients who meet the eligibility criteria for a control or test group of a treatment that has less than 30% of the patients who would qualify for the clinical trial;
   iii. patients who meet the eligibility criteria for a control or test group of a treatment that has high monetary value to a drug manufacturer;
   iv. patients who meet the eligibility criteria for a control or test group of a treatment and have a health record that is at least 50% complete;
   v. patients who are normal healthy subjects in a hospital electronic health record and meet the eligibility criteria for a clinical trial;
   vi. patients who meet the eligibility criteria for study subjects of a treatment of a disease that is of a high priority; and
   vii. any combinations thereof.
35. The system of any of paragraphs 14-34, wherein the at least one database comprises a first database and a second database, wherein the first database comprises the patient profiles, and the second database comprises data associated with eligibility criteria of the clinical trials.
36. The system of any of paragraphs 14-35, wherein the at least one database is stored in a remote computer system over a network.
37. The system of any of paragraphs 14-36, wherein the at least one database is stored locally in the computer system.
38. The system of any of paragraphs 1-37, wherein the one or more programs further comprise instructions for connecting the computer system to the at least one database.
39. The system of any of paragraphs 1-38, wherein the content comprising the signal is displayed on a computer display, a screen, a monitor, an email, a text message, a website, a physical printout (e.g., paper) or provided as stored information in a storage device.
40. A computer implemented method for selecting study subjects for at least one clinical trial comprising: on a computer device having one or more processors and a memory storing one or more programs for execution by the one or more processors, the one or more programs including instructions for:
   i. computing, for each patient in a patient population, a value as a function of parameters comprising:
      a. supply of qualified patients for at least a subset of clinical trials, wherein said each patient is qualified for the at least a subset of the clinical trials; and wherein the supply of the qualified patients is identified based on patient profiles and eligibility criteria of the clinical trials;
      b. demand for study subjects of the at least a subset of the clinical trials; and
   ii. displaying a content that comprises a signal indicative of information associated with at least a subset of the patient population, wherein the signal is selected from the group consisting of a signal indicative of ranking of at least a subset of the patient population, a signal indicative of values of at least a subset of the patient population, a signal indicative of at least of a subset of the patient population selected for the clinical trial, a signal indicative of no patient selected for the clinical trial, and any combination thereof,
thereby selecting patients of high value as study subjects for the at least one clinical trial
41. The computer implemented method of paragraph 40, wherein the patients of high value can be selected based on the values computed for the patients.
42. The computer implemented method of paragraph 40 or 41, wherein the parameters for computing the value of the each patient further comprises an expected screening cost associated with identifying the qualified patient, an expected efficiency of identifying the qualified patient, an expected time cost associated with duration of the clinical trials, or any combinations thereof.
43. The computer implemented method of paragraph 42, wherein the expected efficiency of identifying the qualified patient is characterized by sensitivity, specificity, and/or positive predictive value of at least one method used for identifying the qualified patient for the clinical trials.
44. The computer implemented method of paragraph 43, further comprising ranking the at least one method used for identifying the qualified patient for the clinical trials.
45. The computer implemented method of any of paragraphs 42-44, further comprising optimizing the expected screening cost, the expected efficiency of identifying the qualified patient, and/or the expected time cost.
46. The computer implemented method of any of paragraphs 42-45, wherein the expected time cost is associated with the number of years remaining between completion of the clinical trial and expiration of a patent for a drug to be studied in the clinical trial.
47. The computer implemented method of paragraph 45 or 46, wherein the optimization is performed to minimize overall cost of selecting the study subjects for the at least one clinical trial.
48. The computer implemented method of any of paragraphs 40-47, wherein the computing step (a) comprises:
   (I) computing, for said each patient in the patient population, a first trial-specific value to a first clinical trial as a function of parameters comprising (i) expected compensation for each study subject (Compₓ₌₁), (ii) eligibility of the patient to the first clinical trial (Eligibilityₓ₌₁); (iii) demand for study subjects in the first clinical trial (Demandₓ₌₁); and (iv) supply of qualified patients in the first clinical trial (Supplyₓ₌₁); and
   (II) computing, for said each patient, the value based on at least the first trial-specific value to the first clinical trial computed in (I) and a second trial-specific value of the patient to a second clinical trial.
49. The computer implemented method of paragraph 48, wherein, for said each patient y, the first trial-specific value to the first clinical trial (Vₓ₌₁) and the second trial-specific value to the second clinical trial (Vₓ₌₂) are each independently computed with the following correlation (1):

$${V}_{x} ( patient\_y ) ∼ {Comp}_{x} * {Eligibility}_{x} * \frac{{Demand}_{x}}{{Supply}_{x}} \qquad Correlation ( 1 )$$

50. The computer implemented method of paragraph 48 or 49, wherein, for said each patient y, the value (V) is computed with the following correlation (2):

$$V ( patient\_y ) ∼ {\sum }_{x = 1} {Comp}_{x} * {Eligibility}_{x} * \frac{{Demand}_{x}}{{Supply}_{x}} \qquad Correlation ( 2 )$$

51. The computer implemented method of paragraph 49 or 50, wherein the Eligibilityₓ in Correlation (1) or (2) is corrected by a factor of a positive predictive value.
52. The computer implemented method of any of paragraphs 49-51, wherein computation of the Vₓ(patient_y) in Correlation (1) includes an expected screening cost associated with identifying the patient, an expected efficiency of identifying the patient, or a combination thereof.
53. The computer implemented method of any of paragraphs 40-52, further comprising searching at least one database comprising the patient profiles to identify the qualified patients.
54. The computer implemented method of any of paragraphs 40-53, wherein the patient profiles are derived from electronic health records of the patient population.
55. The computer implemented method of paragraph 53 or 54, wherein the searching comprises comparing, for each patient in the patient population, a feature set associated with the patient to the eligibility criteria of the clinical trials, wherein the feature set comprises at least demographic features of the patient.
56. The computer implemented method of paragraph 55, wherein the at least one demographic feature is selected from the group consisting of gender, age, ethnicity, knowledge of languages, disabilities, mobility, home ownership, employment status, and location.
57. The computer implemented method of paragraph 55 or 56, wherein the feature set further comprises information associated with the patient's diagnosis, procedures, laboratory measurements, medication prescribed or any combinations thereof.
58. The computer implemented method of any of paragraphs 55-57, wherein the feature set further comprises the patient's family history, environment-associated history, psychiatric history, or any combinations thereof.
59. The computer implemented method of any of paragraphs 55-58, wherein the feature set further comprises the patient's usage of social media including usage frequency and content distributed in the social media.
60. The computer implemented method of paragraph 59, wherein electronic personality (e-personality) of the patient contributes to determination of the value of the patient.
61. The computer implemented method of any of paragraphs 40-60, wherein the value of the each patient corresponds to degree of desirability of the each patient as a study subject in one or more clinical trials.
62. The computer implemented method of any of paragraph 40-61, wherein the value of the each patient is expressed as a monetary amount of which the patient is worth.
63. The computer implemented method of any of paragraphs 40-61, wherein the value of the each patient is expressed as an index score relative to other patients.
64. The computer implemented method of paragraph 63, wherein the index score comprises a number, an alphabet, and/or a word.
65. The computer implemented method of any of paragraphs 40-64, wherein the value of the each patient is based on a continuous scale.
66. The computer implemented method of any of paragraphs 40-64, wherein the value of the each patient is based on a discrete scale.
67. The computer implemented method of any of paragraphs 40-66, wherein the patients of high value are patients that are more desirable than one or more other patients in the population as control subjects or test subjects.
68. The computer implemented method of any of paragraphs 40-67, wherein the high value patients can have a smaller value than patients that are less desirable as study subjects in a clinical trial.
69. The computer implemented method of any of paragraphs 40-67, wherein the high value patients can have a higher value than patients that are less desirable as study subjects in a clinical trial.
70. The computer implemented method of any of paragraphs 40-69, wherein, the high value patients can have a monetary woth value in at least the 70% percentile or higher.
71. The computer implemented method of any of paragraphs 40-70, wherein the patients of high value selected for the at least one clinical trial are control subjects.
72. The computer implemented method of any of paragraphs 40-70, wherein the patients of high value selected for the at least clinical trial are test subjects for a treatment with a drug to be studied in the clinical trial.
73. The computer implemented method of any of paragraphs 40-72, wherein the patients of high value are selected from the following patients:
   i. patients who meet the eligibility criteria for a control or test group of a treatment that is being studied by more than one or multiple clinical trials;
   ii. patients who meet the eligibility criteria for a control or test group of a treatment that has less than 30% of the patients who would qualify for the clinical trial;
   iii. patients who meet the eligibility criteria for a control or test group of a treatment that has high monetary value to a drug manufacturer;
   iv. patients who meet the eligibility criteria for a control or test group of a treatment and have a health record that is at least 50% complete;
   v. patients who are normal healthy subjects in a hospital electronic health record and meet the eligibility criteria for a clinical trial;
   vi. patients who meet the eligibility criteria for study subjects of a treatment of a disease that is of a high priority; and
   vii. any combinations thereof.
74. The computer implemented method of any of paragraphs 53-73, wherein the at least one database comprises a first database and a second database, wherein the first database comprises the patient profiles, and the second database comprises data associated with eligibility criteria of the clinical trials.
75. The computer implemented method of any of paragraphs 53-74, wherein the at least one database is stored in a remote computer device over a network.
76. The computer implemented method of any of paragraphs 53-75, wherein the at least one database is stored locally in the computer device.
77. The computer implemented method of any of paragraphs 40-76, wherein the one or more programs further comprise instructions for connecting the computer device to the at least one database.
78. The computer implemented method of any of paragraphs 40-77, wherein the content is displayed on a computer display, a screen, a monitor, an email, a text message, a website, a physical printout (e.g., paper) or provided as stored information in a storage device.
79. The computer implemented method of any of paragraphs 40-78, further comprising identifying one or more clinical trials the patients and/or high value patients should participate in.
80. The computer implemented method of paragraph 79, wherein the one or more clinical trials are identified based on trial-specific values of the patients to the one or more clinical trials and/or the value of the patients.
81. The computer implemented method of any of paragraphs 40-80, furthering comprising determining or estimating a price or compensation of the patients and/or high value patients to participate in a clinical trial.
82. The computer implemented method of paragraph 81, wherein the price or compensation of the patients and/or high value patients is determined or estimated based trial-specific values of the patients to the one or more clinical trials and/or the value of the patients.
83. The computer implemented method of any of paragraphs 40-82, further comprising determining or estimating the cost of patient recruitment for a clinical trial.
84. The computer implemented method of paragraph 83, wherein the cost of patient recruitment for a clinical trial is determined or estimated based trial-specific values of the patients to the one or more clinical trials and/or the value of the patients.
85. The computer implemented method of any of paragraphs 40-84, further comprising adjusting or optimizing one or more parameters involved in the determination of the value of patients, thereby optimizing a recruiting strategy for a clinical trial.
86. The computer implemented method of any of paragraphs 79-85, wherein the method can be performed in a specifically-programmed computer.
87. The computer implemented method of any of paragraphs 79-86, wherein the method can be performed after the values of the patients are computed.
88. A non-transitory computer-readable storage medium storing one or more more programs for selecting study subjects for at least one clinical trial, the one or more programs for execution by one or more processors of a computer system, the one or more programs comprising instructions for:
   i. computing, for each patient in a patient population, a value as a function of parameters comprising:
      a. supply of qualified patients for at least a subset of clinical trials, wherein said each patient is qualified for the at least a subset of the clinical trials; and wherein the supply of the qualified patients is identified based on patient profiles and eligibility criteria of the clinical trials;
      b. demand for study subjects of the at least a subset of the clinical trials; and
   ii. displaying a content that comprises a signal indicative of information associated with at least a subset of the patient population, wherein the signal is selected from the group consisting of a signal indicative of ranking of at least a subset of the patient population, a signal indicative of values of at least a subset of the patient population, a signal indicative of at least of a subset of the patient population selected for the clinical trial, a signal indicative of no patient selected for the clinical trial, and any combination thereof,
thereby selecting patients of high value as study subjects for the at least one clinical trial
89. The non-transitory computer-readable storage medium of paragraph 88, wherein the patients of high value can be selected based on the values computed for the patients.
90. The non-transitory computer-readable storage medium of paragraph 88 or 89, wherein the parameters for computing the value of the each patient further comprises an expected screening cost associated with identifying the qualified patient, an expected efficiency of identifying the qualified patient, an expected time cost associated with duration of the clinical trials, or any combinations thereof.
91. The non-transitory computer-readable storage medium of paragraph 90, wherein the expected efficiency of identifying the qualified patient is characterized by sensitivity, specificity, and/or positive predictive value of at least one method used for identifying the qualified patient for the clinical trials.
92. The non-transitory computer-readable storage medium of paragraph 91, further comprising ranking the at least one method used for identifying the qualified patient for the clinical trials.
93. The non-transitory computer-readable storage medium of any of paragraphs 90-92, further comprising optimizing the expected screening cost, the expected efficiency of identifying the qualified patient, and/or the expected time cost.
94. The non-transitory computer-readable storage medium of any of paragraphs 90-93, wherein the expected time cost is associated with the number of years remaining between completion of the clinical trial and expiration of a patent for a drug to be studied in the clinical trial.
95. The non-transitory computer-readable storage medium of paragraph 93 or 94, wherein the optimization is performed to minimize overall cost of selecting the study subjects for the at least one clinical trial.
96. The non-transitory computer-readable storage medium of any of paragraphs 88-95, wherein the computing step (a) comprises:
   (I) computing, for said each patient in the patient population, a first trial-specific value to a first clinical trial as a function of parameters comprising (i) expected compensation for each study subject (Compₓ₌₁), (ii) eligibility of the patient to the first clinical trial (Eligibilityₓ₌₁); (iii) demand for study subjects in the first clinical trial (Demandₓ₌₁); and (iv) supply of qualified patients in the first clinical trial (Supplyₓ₌₁); and
   (II) computing, for said each patient, the value based on at least the first trial-specific value to the first clinical trial computed in (I) and a second trial-specific value of the patient to a second clinical trial.
97. The non-transitory computer-readable storage medium of paragraph 96, wherein, for said each patient y, the first trial-specific value to the first clinical trial (Vₓ₌₁) and the second trial-specific value to the second clinical trial (Vₓ₌₂) are each independently computed with the following correlation (1):

$${V}_{x} ( patient\_y ) ∼ {Comp}_{x} * {Eligibility}_{x} * \frac{{Demand}_{x}}{{Supply}_{x}} \qquad Correlation ( 1 )$$

98. The non-transitory computer-readable storage medium of paragraph 96 or 97, wherein, for said each patient y, the value (V) is computed with the following correlation (2):

$$V ( patient\_y ) ∼ {\sum }_{x = 1} {Comp}_{x} * {Eligibility}_{x} * \frac{{Demand}_{x}}{{Supply}_{x}} \qquad Correlation ( 2 )$$

99. The non-transitory computer-readable storage medium of paragraph 97 or 98, wherein the Eligibilityₓ in Correlation (1) or (2) is corrected by a factor of a positive predictive value.
100. The non-transitory computer-readable storage medium of any of paragraphs 97-99, wherein computation of the Vₓ(patient_y) in Correlation (1) includes an expected screening cost associated with identifying the patient, an expected efficiency of identifying the patient, or a combination thereof.
101. The non-transitory computer-readable storage medium of any of paragraphs 88-100, the one or more programs further comprise instructions for searching at least one database comprising the patient profiles to identify the qualified patients.
102. The non-transitory computer-readable storage medium of any of paragraphs 88-101, wherein the patient profiles are derived from electronic health records of the patient population.
103. The non-transitory computer-readable storage medium of paragraph 101 or 102, wherein the searching comprises comparing, for each patient in the patient population, a feature set associated with the patient to the eligibility criteria of the clinical trials, wherein the feature set comprises at least demographic features of the patient.
104. The non-transitory computer-readable storage medium of paragraph 103, wherein the at least one demographic feature is selected from the group consisting of gender, age, ethnicity, knowledge of languages, disabilities, mobility, home ownership, employment status, and location.
105. The non-transitory computer-readable storage medium of paragraph 103 or 104, wherein the feature set further comprises information associated with the patient's diagnosis, procedures, laboratory measurements, medication prescribed or any combinations thereof.
106. The non-transitory computer-readable storage medium of any of paragraphs 103-105, wherein the feature set further comprises the patient's family history, environment-associated history, psychiatric history, or any combinations thereof.
107. The non-transitory computer-readable storage medium of any of paragraphs 103-106, wherein the feature set further comprises the patient's usage of social media including usage frequency and content distributed in the social media.
108. The non-transitory computer-readable storage medium of paragraph 107, wherein electronic personality (e-personality) of the patient contributes to determination of the value of the patient.
109. The non-transitory computer-readable storage medium of any of paragraphs 88-108, wherein the value of the each patient corresponds to degree of desirability of the each patient as a study subject in one or more clinical trials.
110. The non-transitory computer-readable storage medium of any of paragraph 88-109, wherein the value of the each patient is expressed as a monetary amount of which the patient is worth.
111. The non-transitory computer-readable storage medium of any of paragraphs 88-109, wherein the value of the each patient is expressed as an index score relative to other patients.
112. The non-transitory computer-readable storage medium of paragraph 111, wherein the index score comprises a number, an alphabet, and/or a word.
113. The non-transitory computer-readable storage medium of any of paragraphs 88-112, wherein the value of the each patient is based on a continuous scale.
114. The non-transitory computer-readable storage medium of any of paragraphs 88-112, wherein the value of the each patient is based on a discrete scale.
115. The non-transitory computer-readable storage medium of any of paragraphs 88-114, wherein the patients of high value are patients that are more desirable than one or more other patients in the population as control subjects or test subjects.
116. The non-transitory computer-readable storage medium of any of paragraphs 88-115, wherein the high value patients can have a smaller value than patients that are less desirable as study subjects in a clinical trial.
117. The non-transitory computer-readable storage medium of any of paragraphs 88-115, wherein the high value patients can have a higher value than patients that are less desirable as study subjects in a clinical trial.
118. The non-transitory computer-readable storage medium of any of paragraphs 88-117, wherein, the high value patients can have a monetary woth value in at least the 70% percentile or higher.
119. The non-transitory computer-readable storage medium of any of paragraphs 88-118, wherein the patients of high value selected for the at least one clinical trial are control subjects.
120. The non-transitory computer-readable storage medium of any of paragraphs 88-119, wherein the patients of high value selected for the at least clinical trial are test subjects for a treatment with a drug to be studied in the clinical trial.
121. The non-transitory computer-readable storage medium of any of paragraphs 88-119, wherein the patients of high value are selected from the following patients:
   i. patients who meet the eligibility criteria for a control or test group of a treatment that is being studied by more than one or multiple clinical trials;
   ii. patients who meet the eligibility criteria for a control or test group of a treatment that has less than 30% of the patients who would qualify for the clinical trial;
   iii. patients who meet the eligibility criteria for a control or test group of a treatment that has high monetary value to a drug manufacturer;
   iv. patients who meet the eligibility criteria for a control or test group of a treatment and have a health record that is at least 50% complete;
   v. patients who are normal healthy subjects in a hospital electronic health record and meet the eligibility criteria for a clinical trial;
   vi. patients who meet the eligibility criteria for study subjects of a treatment of a disease that is of a high priority; and
   vii. any combinations thereof.
122. The non-transitory computer-readable storage medium of any of paragraphs 101-121, wherein the at least one database comprises a first database and a second database, wherein the first database comprises the patient profiles, and the second database comprises data associated with eligibility criteria of the clinical trials.
123. The non-transitory computer-readable storage medium of any of paragraphs 101-122, wherein the at least one database is stored in a remote computer device over a network.
124. The non-transitory computer-readable storage medium of any of paragraphs 101-123, wherein the at least one database is stored locally in the computer device.
125. The non-transitory computer-readable storage medium of any of paragraphs 88-124, wherein the one or more programs further comprise instructions for connecting the computer device to the at least one database.
126. The non-transitory computer-readable storage medium of any of paragraphs 88-125, wherein the content is displayed on a computer display, a screen, a monitor, an email, a text message, a website, a physical printout (e.g., paper) or provided as stored information in a storage device.
127. The non-transitory computer-readable storage medium of any of paragraphs 88-126, wherein the computer system comprises one or more processors; and memory to store the one or more programs.

### Some Selected Definitions

For convenience, certain terms employed in the entire application (including the specification, examples, and appended claims) are collected here. Unless defined otherwise, all technical and scientific terms used herein have the same meaning as commonly understood by one of ordinary skill in the art to which this invention belongs.

It should be understood that this invention is not limited to the particular methodology, protocols, and reagents, etc., described herein and as such may vary. The terminology used herein is for the purpose of describing particular embodiments only, and is not intended to limit the scope of the present invention, which is defined solely by the claims.

Other than in the operating examples, or where otherwise indicated, all numbers expressing quantities of ingredients or reaction conditions used herein should be understood as modified in all instances by the term “about.” The term “about” when used to described the present invention, in connection with numeric values means±5%.

In one aspect, the present invention relates to the herein described compositions, methods, and respective component(s) thereof, as essential to the invention, yet open to the inclusion of unspecified elements, essential or not (“comprising”). In some embodiments, other elements to be included in the description of the composition, method or respective component thereof are limited to those that do not materially affect the basic and novel characteristic(s) of the invention (“consisting essentially of”). This applies equally to steps within a described method as well as compositions and components therein. In other embodiments, the inventions, compositions, methods, and respective components thereof, described herein are intended to be exclusive of any element not deemed an essential element to the component, composition or method (“consisting of”).

As used herein, the term “a subset” refers to at least one or more, including, e.g., at least 2, at least 3, at least 4, at least 5, at least 10, at least 50, at least 100, at least 500, at least 1000, at least 10,000, at least 100,000 or more. In some embodiments, the term “a subset” can be expressed as a percentage greater than zero, e.g., ranging from 1% to 100%.

### EXAMPLES

### Example 1

### Exemplary Methods to Determine Patient Value and Select Study Subjects for a Clinical Trial

The eligibility criteria data of clinical trials can be obtained, e.g., from ClinicalTrials.gov, which is a registry and results database of publicly and privately supported clinical studies of human participants conducted around the world. Information (e.g., patient eligibility criteria) of clinical trials of interest can be extracted based on diseases/conditions. In one embodiment, the information can be represented as Medical Subject Headings (MeSH). Medical Subject Headings (MeSH) is a controlled vocabulary for disease/condition, treatment/intervention, and health services administration. MeSH is one of the controlled vocabularies included within the Unified Medical Language System (UMLS).

When information in clinical trial database and patient profile database are presented in different medical vocabularies, the information in one medical vocabulary can be mapped or converted to another medical vocabulary. For example, in ClinicalTrials.gov database, diseases and conditions related to studies are generally listed in MeSH. However, diagnoses in patient profile database (e.g., health insurance data, and/or hospital or clinic data) can be recorded in a different controlled medical vocabulary, e.g., International Classification of Diseases, 9^{th} Edition (ICD9). In this instance, the mapping is needed to match clinical trials to the right patients in the patient profile database. Accordingly, in some embodiments, the eligibility criteria (e.g., represented by one medical vocabulary such as MeSH) can be mapped or converted to another controlled medical vocabulary, e.g., but not limited to, ICD9.

In one embodiment, UMLS can be used to facilitate conversion of medical information from one controlled medical vocabulary to another. The UMLS Metathesaurus is a database of biomedical concepts, which are linked to the corresponding concepts in the source vocabularies, such as MeSH and ICD9. By way of example only, if two concepts in MeSH and ICD9 are linked to the same UMLS concept, then the MeSH and ICD9 concepts have a similar meaning. Both MeSH and ICD9 are organized in a concept heirachy, with broad concepts at the top levels and more specific concepts at the bottom. This can be used to expand the mappings. For example, the MeSH heading Cardiovascular Diseases can be mapped, using both UMLS and the ICD9 heirarchy, to any specific cardiovascular disease, such as Myocardial Infarction (heart attack).

For illustration purpose only, based on a snapshot of the clinical trial database, e.g., from May 1, 2012, about 28,678 trials were identified whose metadata both indicated that the trial was actively recruiting and included at least one MeSH heading. Using UMLS and the ICD9 heirarchy, the MeSH headings for each trial were mapped to the corresponding ICD9 codes and all ICD9 codes that have a more specific meaning (i.e., all the codes in the subtrees of the ICD9 heirarchy).

Patient profiles or feature sets associated with patients (e.g., but not limited to, demographics (e.g., age and gender), length of enrollment, and/or diagnoses) used in the methods of selecting study subjects for at least one clinical trials described herein can be obtained, e.g., from hospitals, clinics, health care companies, and/or health insurance companies. In one embodiment, patient profiles or feature sets associated with patients can be obtained from a health insurance company. In some embodiments, only profiles or feature sets associated with patients who have been enrolled for a pre-determined period of time, e.g., at least 1 year or more, including, e.g., at least 2 years, at least 3 years, at least 4 years, or more, are used in the methods for selecting study subjects for at least one clinical trials described herein.

By way of example only, a patient profile database can comprise a set of data files providing information on patients or patient members. One data file can list the demographics (e.g., year of birth, age, and/or gender), another can list the months they were enrolled, and a third can inlide their diagnoses represented by a medical vocabulary (e.g., ICD9). In some embodiments, all patients in the database can be used in the clinical trial-patient matching process as described herein. In some embodiments, a portion of patients, e.g., based on their length of enrollment period and diagnoses, can be used in the clinical trial-patient matching process as described herein. In this Example, patient information was obtained from a health insurance company. To simplify the computation, 1 million random patients who were enrolled for all 41 months and had at least one ICD9 diagnoses were selected from the database. This gave patients an equal chance of being matched to clinical trials. For example, a lack of diagnoses for a patient who had only been enrolled for one month could indicate that either the patient is truly healthy, or that she or he might simply not have visited a clinician during that month. It can be more difficult to compare the value of that patient to one that has been enrolled for a longer period, than to compare two patients enrolled for about the same period. Limiting the total number of patients to 1 million for this Example simply made the computation run faster. The same approach can be applied to a larger set of patients.

The selected patients with one or more diagnoses (e.g., represented by one of the controlled medical vocabularies, e.g., ICD9) can then be matched to the eligibility criteria of clinical trials of interest, e.g., based on age, gender, and diagnoses (diseases or conditions), to identify eligible patients for clinical trials and thus to determine patient value. The patient-trial matching can be computationally performed on a large scale, e.g., involving millions and billions of patient-trial matches.

While in this Example, age, gender and diagnoses were used to match patients to appropriate clinical trials, more sophisticated matching parameters or methods can be used or added, depending on what data are available and/or what eligibility requriements of clinical trials are. For example, if the patient profile database can include the patients' zip codes, one can further match clinical trials only to patients who live in the same states where the trials are being conducted. In some embodiments where the clinical trials can have eligibility requirements based on patients' records on procedures, medications, laboratory test results, or a combination thereof, the patient profile database can include these types of data as well for matching patients to appropriate clinical trials.

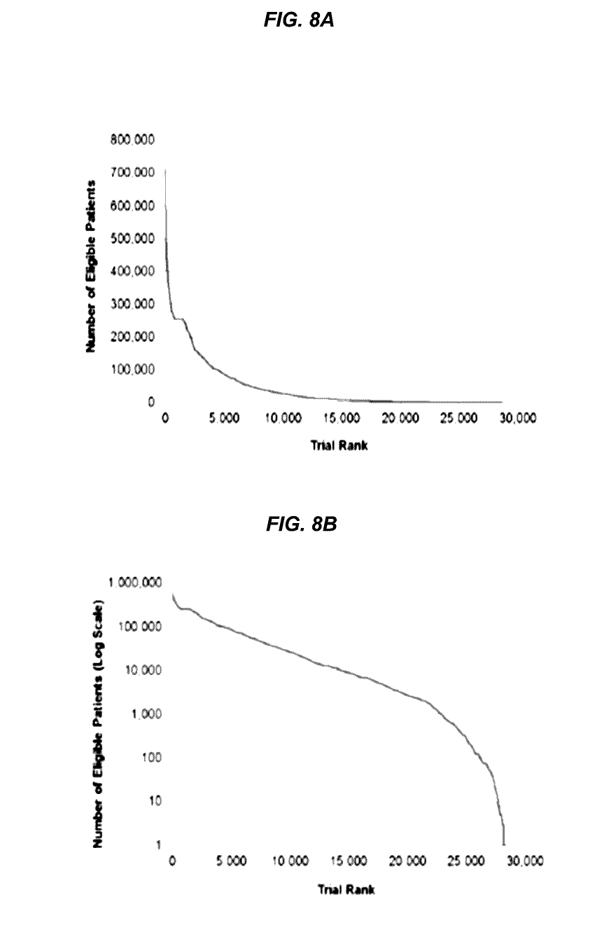

FIGS. 8A-8B show that half of the trials have fewer than 10,000 eligible patients, and about ⅙ of clinical trials have more than 100,000 eligible patients.

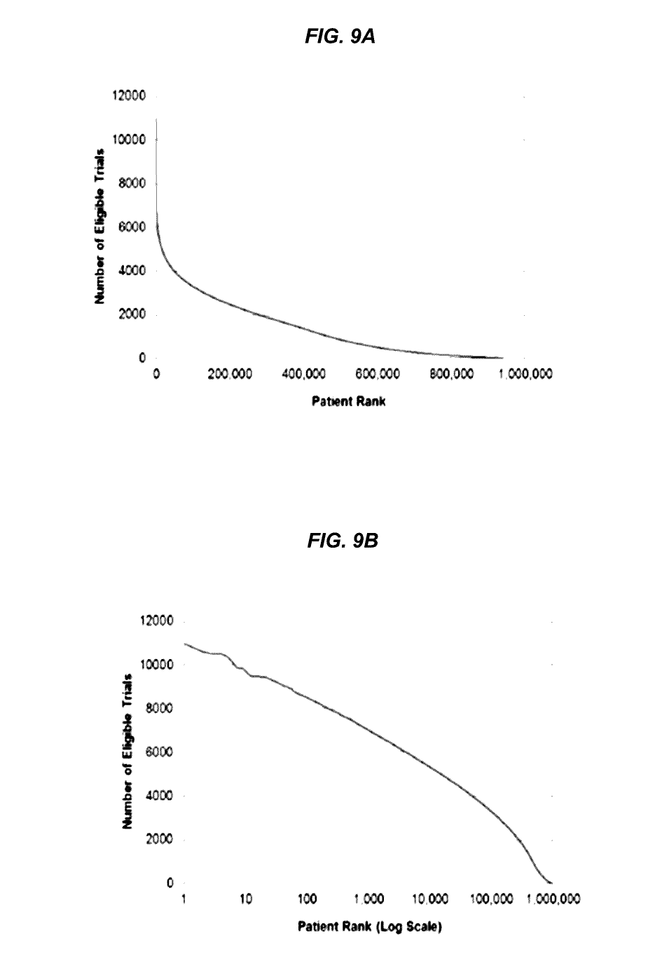

The value of a patient depends on the number of clinical trials he or she is eligible for. The higher the number of clinical trials a patient is eligible for, the higher the value of the patient is. As shown in FIGS. 9A-9B, higher value patients, i.e., patients who are eligible for more clinical trials, have a higher rank. About 10% of patients are eligible for more than 3000 clinical trials. About 25% of patients are eligible for less than 200 trials. About 7% of patients are eligible for no clinical trials.

The patient rank can be represented by numeric values, words, alphabets, or a combination thereof. In FIGS. 9A-9B, the patient rank is represented by a numeric value, where the smaller the number it is, the higher rank the patient is at, or stated another way, the more clinical trials the patient is eligible for. Depending on the ranking scheme, in alternative embodiments, the larger the number it is, the higher rank the patient is at, or stated another way, the more clinical trials the patient is eligible for.

A patient value can correspond to an individual patient, or a group of patients with at least one common characteristic, e.g., but not limited to, age, gender, and/or diagnosis. When a patient value corresponds to an individual patient, the patient value is proportional to the number of clinical trials he or she is eligible for. When a patient value corresponds to a set of patients that are eligible for a clinical trial, the group patient value is the mean value of those patients, which corresponds to the mean number of eligible clinical trials per eligible patient. Stated another way, it is a measure of the average value of the patients a clinical trial is trying to recruit.

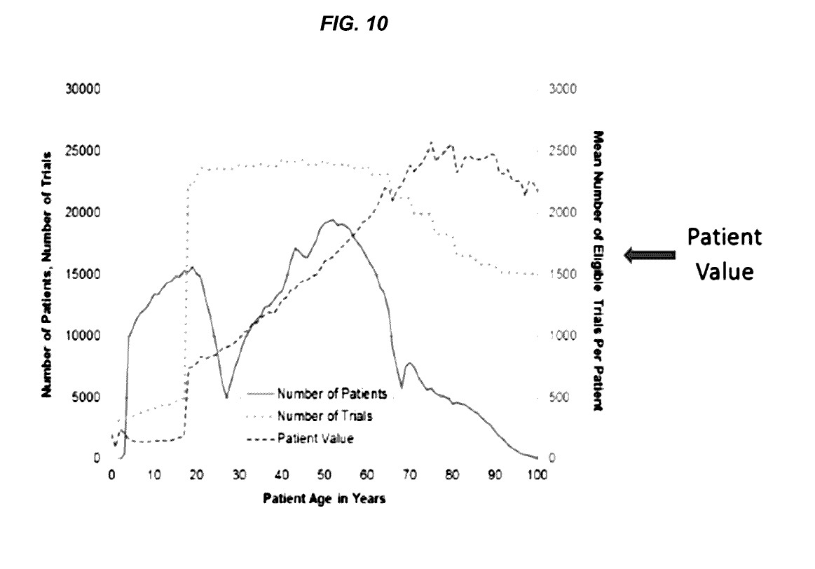

FIG. 10 shows a supply and demand of patients for clinical trials. In the figure, clinical trials seek patients that are 20-65 years old, while patient age distribution peaks at 20 and 50 years. FIG. 10 also shows that older patients are of more value because they are eligible for more clinical trials, as evidenced by a higher mean number of eligible trials per patient. In this figure, the patient value is determined by averaging the total number of eligible trials for patients in a specific age group over the number of patients in that age group.

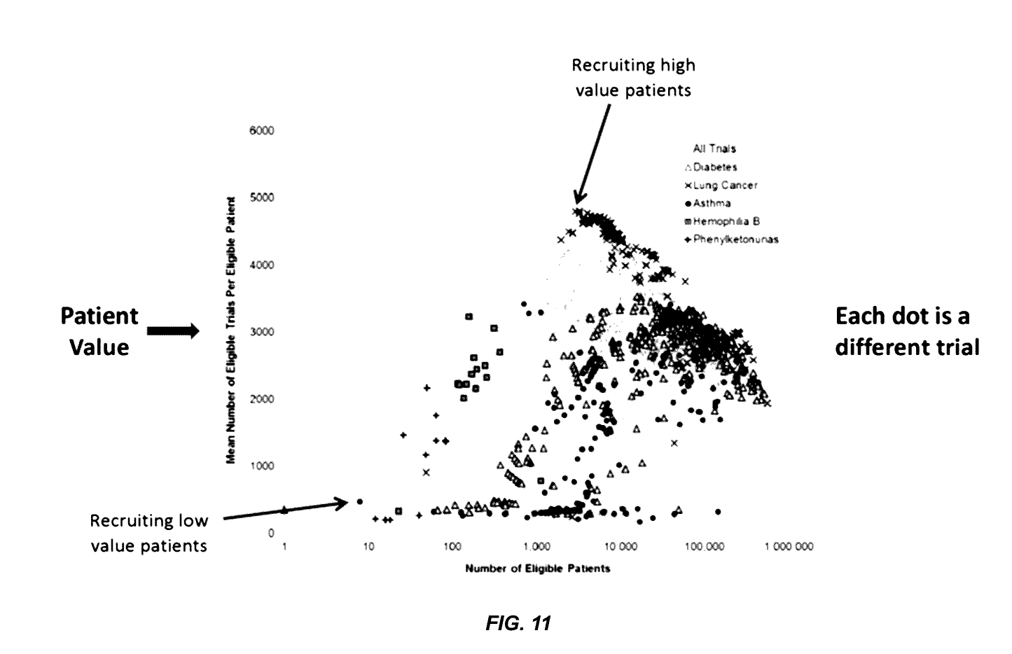

In FIG. 11, each dot represents a clinical trial. The horizontal axis is the number of patients who are eligible for those trials. The vertical axis is the mean value of those patients, i.e., determined by averaging the total number of eligible trials for patients who are eligible for a specific clinical trial over the number of eligible patients in that specific clinical trial. Trials in the upper right portion of the figure, for example, have many eligible patients, but on average those patients are also in demand from many other trials. There are only a few patients who are eligible for the trials in the lower left portion of the figure, but not many trials are seeking those patients. A trial in the lower-right portion of the figure is in the ideal position because it can select from a large number of low value eligible patients.

### Example 2

### Example Application of the Methods Described Herein to Determine Patient Value and Select Patients for a Lung Cancer Clinical Trial

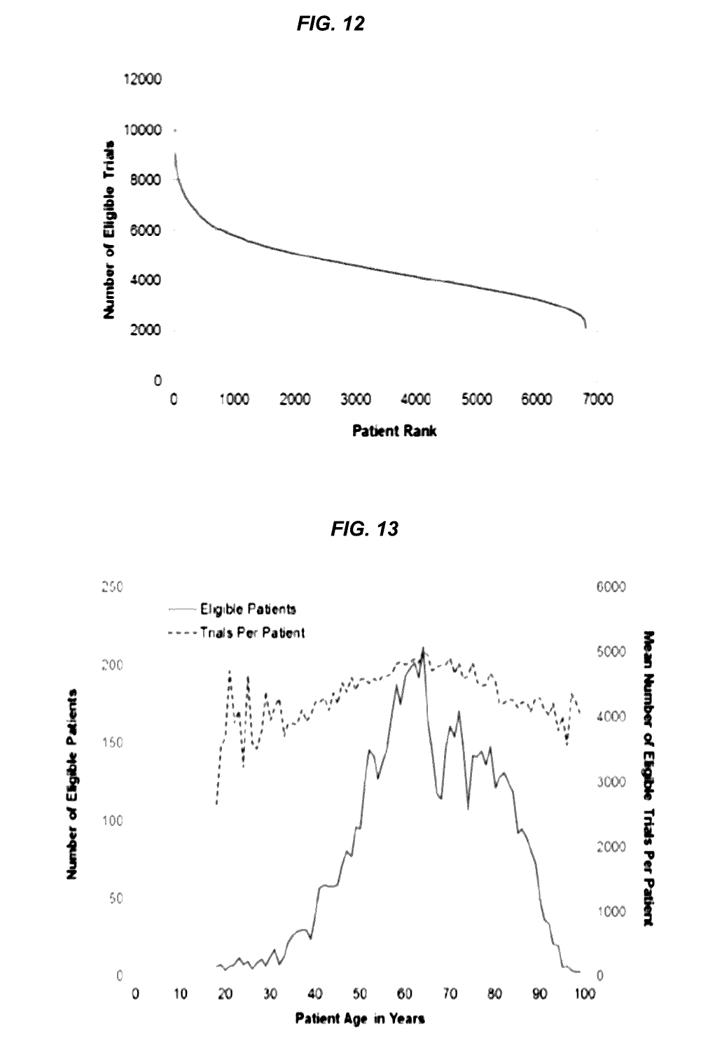

In this example, an actual clinical trial seeks 400 lung patients. Using the methods as described in Example 1, it was determined that there are about 6750 eligible patients out of the 1 million patient sample. As shown in FIG. 12, those patients are also eligible for about 2125 to 10525 other trials. The first 400 highest rank patients are eligible for a mean of about 7499 trials. The last 400 lowest rank patients are eligible for a mean of about 2741 trials.

FIG. 13 shows that the peak age of eligible patients is about 60 years. However, those patients are also eligible for the most number of other trials (highest value).

For each patient, the number of trials that she or he is eligible for (i.e. the patient value) was determined. FIG. 13 represents just those patients eligible for this particular trial. (However, their value is based on all trials.) The dashed line represents the mean patient value of all patients of a given age who are eligible for this trial. In other words, each point on the dashed curve represents a group of patients who are of the same age.

The patients that are eligible for the lung cancer clinical trial can also be eligible for clinical trials of other diseases or conditions. Table 2 below shows that clinical trials studying other diseases or conditions can be also trying to enroll the same 6750 lung cancer patients. For example, subsets of those patients are also eligible for 1537 trials seeking patients with any neoplasm or 1018 trials seeking patients with diabetes mellitus.

TABLE 2
Number of clinical trials of other disease or conditions for
which the 6750 lung cancer patients are also eligible.

| MeSH Descriptor | Trials | Patient-Trial Pairs |
|---|---|---|
| Neoplasms | 1537 | 8646182 |
| Lung Neoplasms | 860 | 5513269 |
| Lung Diseases | 345 | 2046992 |
| Pulmonary Disease, Chronic Obstructive | 315 | 1705740 |
| Lung Diseases, Obstructive | 281 | 1593439 |
| Breast Neoplasms | 1280 | 1517194 |
| Respiration Disorders | 259 | 1513316 |
| Carcinoma | 995 | 1510744 |
| Diabetes Mellitus | 1018 | 1024403 |
| Coronary Artery Disease | 600 | 999917 |
| Myocardial Ischemia | 566 | 967184 |
| Lymphoma | 870 | 924898 |
| Cardiovascular Diseases | 269 | 920279 |
| Colorectal Neoplasms | 520 | 853242 |
| Coronary Disease | 516 | 818418 |
| Kidney Diseases | 390 | 809956 |
| Depression | 662 | 773314 |
| Depressive Disorder | 657 | 768940 |
| Esophageal Diseases | 216 | 765530 |
| Heart Diseases | 239 | 741544 |

All patents, patent applications, and publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

1. A system for selecting study subjects for at least one clinical trial comprising: a computer system comprising one or more processors; and memory to store one or more programs, the one or more programs comprising instructions for:
i. computing, for each patient in a patient population, a value as a function of parameters comprising:
a. supply of qualified patients for at least a subset of clinical trials, wherein said each patient is qualified for the at least a subset of the clinical trials; and wherein the supply of the qualified patients is identified based on patient profiles and eligibility criteria of the clinical trials;
b. demand for study subjects of the at least a subset of the clinical trials; and
ii. displaying a content that comprises a signal indicative of information associated with at least a subset of the patient population, wherein the signal is selected from the group consisting of a signal indicative of ranking of at least a subset of the patient population, a signal indicative of values of at least a subset of the patient population, a signal indicative of at least a subset of the patient population selected for the clinical trial, a signal indicative of no patient selected for the clinical trial, and any combination thereof,
thereby selecting patients of high value as study subjects for the at least one clinical trial.

2. The system of claim 1, wherein the patients of high value can be selected based on the values computed for the patients.

3. The system of claim 1, wherein the parameters for computing the value of the each patient further comprises an expected screening cost associated with identifying the qualified patient, an expected efficiency of identifying the qualified patient, an expected time cost associated with duration of the clinical trials, or any combinations thereof.

4. The system of claim 3, wherein the expected efficiency of identifying the qualified patient is characterized by sensitivity, specificity, and/or positive predictive value of at least one method used for identifying the qualified patient for the clinical trials.

5. The system of claim 4, further comprising ranking the at least one method used for identifying the qualified patient for the clinical trials.

6. The system of claim 2, further comprising optimizing the expected screening cost, the expected efficiency of identifying the qualified patient, and/or the expected time cost.

7. The system of claim 2, wherein the expected time cost is associated with the number of years remaining between completion of the clinical trial and expiration of a patent for a drug to be studied in the clinical trial.

8. The system of claim 6, wherein the optimization is performed to minimize overall cost of selecting the study subjects for the at least one clinical trial.

9. The system of claim 1, wherein the computing step (a) comprises:
(I) computing, for said each patient in the patient population, a first trial-specific value to a first clinical trial as a function of parameters comprising (i) expected compensation for each study subject (Compₓ₌₁), (ii) eligibility of the patient to the first clinical trial (Eligibilityₓ₌₁); (iii) demand for study subjects in the first clinical trial (Demandₓ₌₁); and (iv) supply of qualified patients in the first clinical trial (Supplyₓ₌₁); and
(II) computing, for said each patient, the value based on at least the first trial-specific value to the first clinical trial computed in (I) and a second trial-specific value of the patient to a second clinical trial.

10. The system of claim 9, wherein, for said each patient y, the first trial-specific value to the first clinical trial (Vₓ₌₁) and the second trial-specific value to the second clinical trial (Vₓ₌₂) are each independently computed with the following correlation (1):
$${V}_{x} ( patient\_y ) ∼ {Comp}_{x} * {Eligibility}_{x} * \frac{{Demand}_{x}}{{Supply}_{x}} \qquad Correlation ( 1 )$$

11. The system of claim 9, wherein, for said each patient y, the value (V) is computed with the following correlation (2):
$$V ( patient\_y ) ∼ {\sum }_{x = 1} {Comp}_{x} * {Eligibility}_{x} * \frac{{Demand}_{x}}{{Supply}_{x}} \qquad Correlation ( 2 )$$

12. The system of claim 10, wherein the Eligibilityₓ in Correlation (1) or (2) is corrected by a factor of a positive predictive value.

13. The system of claim 10, wherein computation of the Vₓ(patient_y) in Correlation (1) includes an expected screening cost associated with identifying the patient, an expected efficiency of identifying the patient, or a combination thereof.

14. The system of claim 1, further comprising searching at least one database comprising the patient profiles to identify the qualified patients.

15. The system of claim 1, wherein the patient profiles are derived from electronic health records of the patient population.

16. The system of claim 14, wherein the searching comprises comparing, for each patient in the patient population, a feature set associated with the patient to the eligibility criteria of the clinical trials, wherein the feature set comprises at least demographic features of the patient.

17. The system of claim 16, wherein the at least one demographic feature is selected from the group consisting of gender, age, ethnicity, knowledge of languages, disabilities, mobility, home ownership, employment status, and location.

18. The system of claim 16, wherein the feature set further comprises information associated with the patient's diagnosis, procedures, laboratory measurements, medication prescribed or any combinations thereof.

19. The system of claim 16, wherein the feature set further comprises the patient's family history, environment-associated history, psychiatric history, or any combinations thereof.

20. The system of claim 16, wherein the feature set further comprises the patient's usage of social media including usage frequency and content distributed in the social media.

21.-127. (canceled)
